(19) United States
(12) Patent Application Publication
(10) Pub. No.: US 2025/0102990 A1
(43) Pub. Date: Mar. 27, 2025

(54) IMAGE FORMING SYSTEM AND IMAGE FORMING METHOD

(71) Applicant: Konica Minolta, Inc., Tokyo (JP)

(72) Inventors: Tomoko MINE, Tokyo (JP); Kaori MATSUSHIMA, Tokyo (JP); Akihiko ITAMI, Tokyo (JP)

(21) Appl. No.: 18/771,236

(22) Filed: Jul. 12, 2024

(30) Foreign Application Priority Data
Jul. 21, 2023 (JP) 2023-118727

(51) Int. Cl. G03G 15/00; G03G 5/10; G03G 9/113; G03G 15/08

(52) U.S. Cl. CPC G03G 15/751; G03G 5/102; G03G 9/1133; G03G 9/1139; G03G 15/0818; G03G 2215/0607

(57) ABSTRACT

An image forming system including: a two-component developer; and an image forming apparatus including at least one of a photoreceptor including a support made of an aluminum alloy or a developer bearing member including a developing sleeve made of an aluminum alloy. A static resistance value of a carrier contained in the two-component developer is in a range of 10⁸ Ω·cm or more and less than 10¹² Ω·cm. A silicon content in the aluminum alloy forming at least the support of the photoreceptor or the developing sleeve of the developer bearing member is in a range of more than 0.6% by mass and 12.6% by mass or less.

### CROSS-REFERENCE TO RELATED APPLICATIONS

The entire disclosure of Japanese Patent Application No. 2023-118727, filed on Jul. 21, 2023, including description, claims, drawings and abstract is incorporated herein by reference.

### BACKGROUND OF THE INVENTION

### Technical Field

The present invention relates to an image forming system and an image forming method. More specifically, the present invention relates to an image forming system and an image forming method capable of suppressing excessive charging of a toner for developing electrostatic charge image and obtaining a good image even in a low-temperature and low-humidity environment.

### Description of Related Art

In recent years, environmental load reduction has been required in various members constituting a main body of an image forming apparatus using an electrophotographic method.

One of conceivable means for reducing environmental loads, is to use a material that emits a small amount of carbon dioxide per unit mass when the above-described various members are produced. For example, in the case of a member using an aluminum alloy, a large amount of carbon dioxide is discharged in the process of producing aluminum from bauxite, and thus the environmental load is large. On the other hand, the use of an aluminum alloy recycled from a waste material containing aluminum eliminates the process of producing aluminum from bauxite. Thus, the amount of carbon dioxide emission can be significantly reduced, and the environmental load can be reduced.

In those aluminum alloys, regardless of whether the alloys are recycled or not, elements other than aluminum are added for the purpose of controlling physical properties and processability. In particular, silicon is added to various kinds of aluminum alloys because it has effects on heat resistance, thermal expansibility, and processability.

As an example of utilizing such silicon-containing aluminum alloys for a member of an image forming apparatus using an electrophotographic method, JP 2022-132142A discloses an electrophotographic photoreceptor using a silicon-containing aluminum alloy for a support.

Furthermore, JP 2008-102502A discloses a developer bearing member using a silicon-containing aluminum alloy.

Meanwhile, when an aluminum alloy is produced by recycling as described above, it is necessary to detect and remove impurities and the like including silicon, and adjust the contents of those.

### SUMMARY OF THE INVENTION

However, since silicon is highly difficult to separate and remove, the silicon content in an aluminum alloy produced by recycling is higher than necessary. When such an alloy is used for the above-described various members, the members might not satisfy desired performance.

Thus, improvements has been desired in those to satisfy desired performance even in the case of using a photoreceptor and a developer bearing member using an aluminum alloy having a high silicon content as described above.

The present invention has been made in view of the above problems and circumstances, and an object of the present invention is to provide an image forming system and an image forming method capable of suppressing excessive charging of a toner for developing electrostatic charge image and obtaining a good image even in a low-temperature and low-humidity environment.

The present inventors have investigated the causes and the like of the above-described problems to solve the above-described problems and as a result, have found that the above-described problems can be solved by using, in combination, a support of a photoreceptor or a developing sleeve of a developer bearing member in which the silicon content in an aluminum alloy is in a certain range, and a two-component developer in which the static resistance value of a carrier is in a certain range, thereby completing the present invention. That is, the above-described problems according to the present invention are solved by the following means.

To achieve at least one of the abovementioned objects, according to an aspect of the present invention, an image forming system reflecting one aspect of the present invention is an image forming system comprising: a two-component developer; and an image forming apparatus comprising at least one of a photoreceptor including a support made of an aluminum alloy or a developer bearing member including a developing sleeve made of an aluminum alloy, wherein
a static resistance value of a carrier contained in the two-component developer is in a range of 10⁸ Ω·cm or more and less than 10¹² Ω·cm, and
a silicon content in the aluminum alloy forming at least the support of the photoreceptor or the developing sleeve of the developer bearing member is in a range of more than 0.6% by mass and 12.6% by mass or less.

To achieve at least one of the abovementioned objects, according to an aspect of the present invention, an image forming method reflecting one aspect of the present invention is an image forming method using a two-component developer; and an image forming apparatus comprising at least one of a photoreceptor including a support made of an aluminum alloy or a developer bearing member including a developing sleeve made of an aluminum alloy, wherein
a static resistance value of a carrier contained in the two-component developer is in a range of 10⁸ Ω·cm or more and less than 10¹² Ω·cm, and
a silicon content in the aluminum alloy forming at least the support of the photoreceptor or the developing sleeve of the developer bearing member is in a range of more than 0.6% by mass and 12.6% by mass or less.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 illustrates an example of a layer configuration of an electrophotographic photoreceptor;

FIG. 2 is an external view of a developer bearing member including a developing sleeve;

FIG. 3 is a cross-sectional view of the developer bearing member having a configuration in which a shaft does not penetrate a magnet roller;

FIG. 4 is a cross-sectional view of the developer bearing member having a configuration in which a shaft penetrates a magnet roller;

FIG. 5 is an explanatory cross-sectional view illustrating an example of a configuration of the image forming apparatus according to the present invention; and

FIG. 6 is a conceptual diagram of an example illustrating a Vpp value of an AC voltage.

### DETAILED DESCRIPTION

Hereinafter, one or more embodiments of the present invention will be described with reference to the drawings. However, the scope of the invention is not limited to the disclosed embodiments.

The image forming system of the present invention is an image forming system comprising: a two-component developer; and an image forming apparatus comprising at least one of a photoreceptor including a support made of an aluminum alloy or a developer bearing member including a developing sleeve made of an aluminum alloy, wherein a static resistance value of a carrier contained in the two-component developer is in a range of 10⁸ Ω·cm or more and less than 10¹² Ω·cm, and a silicon content in the aluminum alloy forming at least the support of the photoreceptor or the developing sleeve is in a range of more than 0.6% by mass and 12.6% by mass or less.

This feature is a technical feature common to or corresponding to the following embodiments (aspects).

In an embodiment of the present invention, it is preferable that the carrier is composed of carrier particles in which at least a surface of core material particles is coated with a coating resin, and the coating resin has a structure derived from a (meth)acrylate, from the viewpoint of reducing the environmental difference in charging.

Furthermore, it is preferable that the coating resin contains at least one of carbon black, magnesium oxide, or titanium dioxide, from the viewpoint of adjusting the static resistance value of the carrier.

The exposed area ratio of the core material particles in a surface of the carrier particles is preferably in a range of 10.0 to 18.0% based on a surface area of the core material particles, from the viewpoint of suppressing excessive charging of carrier particles and suppressing deterioration of the carrier particles.

The silicon content is preferably in a range of more than 0.8% by mass and 12.6% by mass or less based on a total amount of the aluminum alloy forming at least the photoreceptor or the developing sleeve, from the viewpoint of the surface processability of the photoreceptor and the developer bearing member.

The coating resin preferably has a structure derived from an alicyclic (meth)acrylate having high hydrophobicity from the viewpoint of further reducing the environmental difference in chargeability.

The static resistance value of the carrier is preferably in a range of 10⁸ to 10¹⁰ Ω·cm from the viewpoint of capable of suppressing reduction in image density in a low-temperature and low-humidity environment.

The image forming method of the present invention is an image forming method using: a two-component developer; and an image forming apparatus comprising at least one of a photoreceptor including a support made of an aluminum alloy or a developer bearing member including a developing sleeve made of an aluminum alloy, wherein a static resistance value of a carrier contained in the two-component developer is in a range of 10⁸ Ω·cm or more and less than 10¹² Ω·cm, and a silicon content in the aluminum alloy forming at least the support of the photoreceptor or the developing sleeve of the developer bearing member is in a range of more than 0.6% by mass and 12.6% by mass or less. The method can be suitably used for the image forming system of the present invention.

Hereinafter, the present invention, constituent elements thereof, and forms and aspects for carrying out the present invention will be described in detail. In the present description, when two figures are used to indicate a range of value before and after “to”, these figures are included in the range as a lower limit value and an upper limit value.

### [Image Forming System]

The image forming system of the present invention is an image forming system comprising: a two-component developer; and an image forming apparatus comprising at least one of a photoreceptor including a support made of an aluminum alloy or a developer bearing member including a developing sleeve made of an aluminum alloy, wherein a static resistance value of a carrier contained in the two-component developer is in a range of 10⁸ Ω·cm or more and less than 10¹² Ω·cm, and a silicon content in the aluminum alloy forming at least the support of the photoreceptor or the developing sleeve of the developer bearing member is in a range of more than 0.6% by mass and 12.6% by mass or less.

### 1. Two-Component Developer

Two-component developer according to the present invention contains a toner for developing electrostatic charge image (hereinafter, also simply referred to as a “toner”) and a carrier, and the static resistance value of the carrier is in a range of 10⁸ Ω·cm or more and less than 10¹² Ω·cm.

In the two-component developer according to the present invention, a carrier and a toner, which are described in detail below, are preferably used.

Note that the mixing amount of the toner particles is preferably in a range of 1 to 10% by mass based on the entirety of the two-component developer.

### (1.1) Carrier

One of main roles of the carrier contained in the two-component developer according to the present invention is to be stirred and mixed with a toner in the developing box to provide the toner with a desired charge. Another role of the carrier is to serve as an electrode between the developing device and the photoreceptor and to function as a bearing substance (i.e., carrier) that transports the charged toner to an electrostatic latent image on the photoreceptor to form a toner image.

The carrier is held on the magnet roller by a magnetic force, acts on development, then returns to the developing box again, is stirred and mixed with a new toner again, and is repeatedly used for a certain period. Thus, in order to stably maintain desired image characteristics (image density, fogging, white spots, gradation, resolving power, and the like), it is naturally required that the characteristics of the carrier are stable during the period of use.

In the carrier particles composing the carrier according to the present invention, it is preferable that the surface of the core material particles, which are metal powders such as iron, ferrite, and magnetic powders, is coated with a coating resin as described later. The carrier particles may contain an internal additive such as a resistance adjuster, if necessary.

### (1.1.1) Static Resistance Value

The carrier according to the present invention plays a role of transferring a toner onto a photoreceptor, and a static resistance value of the carrier is in a range of 10 Ω·cm or more and less than 10¹² Ω·cm. Thus, even when the developing potential is lowered, a reduction in image density can be prevented, in particular, in a low-temperature and low-humidity environment.

When the static resistance value of the carrier is 10¹² Ω·cm or more, charge movement in the carrier becomes slow, and as a result, the charge rising property of a toner may deteriorate.

The “charge rising property of a toner” is a property of the toner indicating how quickly the potential reaches a desired value when the toner is charged. It is preferable that the static resistance value of the carrier is in the range of 10⁸ to 10¹⁰ Ω·cm because the charge rising property is further improved.

When the static resistance value of the carrier is less than 10⁸ Ω·cm, the toner is not sufficiently charged, and image failure such as fogging may occur. This is because, when the resistance of the carrier is excessively low, the charged electric charge is liable to leak and thus the charge amount of the toner itself decreases.

From the above, the static resistance value of the carrier is preferably in a range of 10⁸ Ω·cm or more and less than 10¹² Ω·cm, and more preferably in a range of 10⁸ to 10¹⁰ Ω·cm.

### (Method for Calculating Static Resistance Value)

The method for calculating the static resistance value of the carrier contained in the two-component developer according to the present invention is as follows. Note that the “static resistance value” is also referred to as a “volume specific resistance value”.

First, a two-component developer containing a carrier whose static resistance value is to be calculated is prepared. Next, the two-component developer is put into an aqueous solution containing a surfactant, and a toner and the carrier are separated from each other by ultrasonic waves. Then, only the carrier is removed and separated from the two-component developer by a magnet. 1.0 gram of the carrier is used as a sample, and the sample is filled in an insulating cylindrical vessel having a cross-sectional area of 1 cm². Note that electrodes having a cross-sectional area of 1.0 cm² are arranged on the top and bottom of the insulating cylindrical vessel.

Next, a thickness t (cm) of the layer formed of the sample is determined under a load of 500 g. Then, a DC voltage 100 V is applied with an insulation resistance meter, and an insulation resistance value R [Ω] at that time is read.

The thickness t [cm] and the insulation resistance value R [Ω] of the layer formed of the sample are substituted to the following expression to calculate a static resistance value.

$$Static resistance value [ Ω \cdot cm ] = R \cdot ( S / t ) \qquad ( Expression 1 )$$

wherein, R [Ω] is an insulation resistance value, S [cm²] is a cross-sectional area of a layer formed of a sample, and t [cm] is a thickness of the layer formed of a sample.

### (1.1.2) Core Material Particles

### (Type)

The core material particles according to the present invention are composed of, for example, an iron powder, various kinds of ferrites, a metal powder such as magnetite, or the like. Among these, ferrites are preferable from the viewpoint that residual magnetization is low and suitable magnetic properties are obtained. The above-described ferrites preferably contain a heavy metal such as copper, zinc, nickel, or manganese, and a light metal such as an alkali metal or an alkaline earth metal.

Note that the ferrite is a compound represented by the following formula (1), and the molar ratio y of the Fe₂O₃ constituting the ferrite is preferably in a range of 30 to 95 mol %.

(MO)ₓ(Fe₂O₃)_{y} Formula (1)
wherein, “M” represents a metal element, “0” represents an oxygen element, “Fe” represents an iron element, and “x” and “y” represent molar ratios.

When the molar ratio y is in a range of 30 to 95 mol %, there are advantages in that desired magnetization is easily obtained and adhesion between carrier particles each other does not easily occur during preparing the carrier particles.

Examples of “M” in formula (1) include manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), and lithium (Li). The metal elements may be used singly or in combination of two or more.

From the viewpoint that the residual magnetization is low and suitable magnetic properties are obtained, manganese, magnesium, strontium, lithium, copper, and zinc are preferable, and among these, manganese and magnesium are more preferable. That is, the core material particles according to the present invention are preferably ferrite particles containing at least one of manganese and magnesium.

Commercially available products or synthesized products may be used as the core material particles.

### (Particle Diameter)

Regarding the particle diameter of the core material particles, the volume-based median diameter (D₅₀) is preferably in a range of 13 to 40 μm, more preferably in a range of 15 to 30 μm. When the volume-based median diameter (D₅₀) of the core material particles is 40 μm or less, it excels in that excellent image quality can be provided without reducing image quality. When the volume-based median diameter (D₅₀) of the core material particles is 13 μm or more, it excels in that the occurrence of the adhesion of the carrier particles to each other can be prevented and excellent image quality with less fogging or the like can be provided.

The volume-based median diameter (D₅₀) of the core material particles can be measured by, for example, a laser diffraction particle size distribution measurement device “HELOS” (manufactured by Sympatec GmbH) equipped with a wet disperser, and the saturation magnetization of the core material particles can be measured by, for example, a “DC magnetization characteristic automatic recorder 3257-35” (manufactured by Yokogawa Electric Corporation).

### (Magnetization)

The core material particles according to the present invention preferably have saturation magnetization in a range of 30 to 80 Am²/kg and residual magnetization of 5.0 Am²/kg or less. By using the core material particles having such magnetic properties, the carrier particles are prevented from being partially aggregated, and the two-component developer is more uniformly dispersed on the surface of the developer conveying member, so that a uniform and fine toner image free from density unevenness can be formed.

### (Synthesis Method)

Examples of the method for synthesizing the core material particles include the following method.

First, appropriate amounts of raw materials are weighed and then pulverized and mixed with a wet media mill, a ball mill, a vibration mill, or the like. The time required for the pulverization and mixing is preferably 0.5 hours or more, more preferably in a range of 1 to 20 hours.

The pulverized product thus obtained is pelletized using a pressure molding machine or the like, and then pre-fired. The temperature required for the pre-firing is preferably in a range of 700 to 1200° C., and the time required for the pre-firing is preferably in a range of 0.5 to 5 hours.

Note that the obtained pulverized product may be pulverized without using a pressure molding machine, or after the pulverization, water may be added to the pulverized product to form a slurry, and the slurry may be granulated with a spray dryer, and then pre-fired.

After the pre-firing, the obtained product is further pulverized with a ball mill, a vibration mill, or the like. At this time, water may be added, and the mixture may be pulverized with a wet ball mill, a wet vibration mill, or the like.

Thereafter, water, a binder such as polyvinyl alcohol (PVA), and the like are added, and if necessary, a dispersant and the like are added to adjust the viscosity, followed by granulation and main-firing. The temperature of the main-firing is preferably in a range of 1000 to 1500° C., and the time of the main-firing is preferably in a range of 1 to 24 hours.

The pulverizers such as the ball mill and the vibration mill are not particularly limited, but it is preferable to use fine beads having a particle diameter of 1 cm or less as media to be used to disperse the raw materials effectively and uniformly. The degree of pulverization can be controlled by adjusting the diameter and composition of the beads to be used and the pulverization time.

The fired product thus obtained is pulverized and classified. As a classification method, an existing air classification method, a mesh filtration method, a sedimentation method, or the like is used to adjust the particle diameter to a desired particle diameter.

Thereafter, if necessary, the fired product which has been pulverized and classified can be subjected to an oxide film treatment by heating the surface of the fired product at a low temperature to adjust the electrical resistance. In addition, if necessary, reduction may be performed before the oxide film treatment, and after the classification, a low-magnetic product may be further classified by magnetic separation.

(1.1.3) Coating resin

### (Type)

The surface of the core material particles according to the present invention is preferably coated with a coating resin, and the coating resin preferably has a structure derived from a (meth)acrylate from the viewpoint of reducing the environmental difference in charging. Note that (meth)acryl herein means acryl or methacryl.

Examples of the compound having a structure derived from a (meth)acrylate include a methacrylic acid ester compound, an acrylic acid ester compound, and an alicyclic (meth)acrylic acid ester compound.

Among these, in particular, the alicyclic (meth)acrylic acid ester compound is more preferable since the alicyclic (meth)acrylic acid ester compound has high hydrophobicity, the amount of moisture adsorbed to the carrier particles in a high-temperature and high-humidity environment is reduced, and a reduction in charge amount is prevented.

Specific examples of the methacrylic acid ester compound include methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, benzyl methacrylate, isobornyl methacrylate, diethylaminoethyl methacrylate, and dimethylaminoethyl methacrylate.

Specific examples of the acrylic acid ester compound include methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and benzyl acrylate.

Specific examples of the alicyclic (meth)acrylic acid ester compound include isobornyl acrylate, dicyclopentanyl acrylate, cyclohexyl acrylate, methylcyclohexyl acrylate, trimethylcyclohexyl acrylate, t-butylcyclohexyl acrylate, cyclohexylphenyl acrylate, cyclododecyl acrylate, adamantyl acrylate, cyclopentyl methacrylate, cyclohexyl methacrylate, cycloheptyl methacrylate, and cyclooctyl methacrylate. Among these, from the viewpoint of the environmental stability of charge amount and the like, those having a cycloalkyl group having 5 to 8 carbon atoms are preferable, and cyclohexyl methacrylate is more preferable.

Other monomers besides the (meth)acrylic acid ester compound may be used as the monomers constituting the coating resin. Examples of other monomers include styrene compounds, (meth)acrylic acid, olefin compounds, halogenated vinyl compounds, vinyl ester compounds, vinyl ether compounds, vinyl ketone compounds, N-vinyl compounds, vinyl compounds, and acrylic acid or methacrylic acid derivatives.

Specific examples of the styrene compounds include styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

Specific examples of the (meth)acrylic acid include methacrylic acid, acrylic acid, and itaconic acid.

Specific examples of the olefin compounds include ethylene, propylene, and isobutylene.

Specific examples of the halogenated vinyl compounds include vinyl chloride, vinylidene chloride, vinyl bromide, vinyl fluoride, and vinylidene fluoride.

Specific examples of the vinyl ester compounds include vinyl propionate, vinyl acetate, and vinyl benzoate.

Specific examples of the vinyl ether compounds include vinyl methyl ether and vinyl ethyl ether.

Specific examples of the vinyl ketone compounds include vinyl methyl ketone, vinyl ethyl ketone, and vinyl hexyl ketone.

Specific examples of the N-vinyl compounds include N-vinylcarbazole, N-vinylindole, and N-vinylpyrrolidone.

Specific examples of the vinyl compounds include vinylnaphthalene and vinylpyridine.

Specific examples of the acrylic acid or methacrylic acid derivatives include acrylonitrile, methacrylonitrile, and acrylamide.

These other monomers may be used singly or in combination of two or more. Among these other monomers, styrene and methacrylic acid are preferable from the viewpoint of the environmental stability in charge amount, and the like.

The ratio of the constituent unit derived from a (meth)acrylic acid ester compound to the constituent unit derived from other monomers in the coating resin is preferably 10:90 to 100:0, and more preferably 30:70 to 70:30.

### (Weight Average Molecular Weight)

The weight average molecular weight of the coating resin, that is, the polymer obtained by polymerizing the above-described monomer, is not particularly limited as long as it is in a range in which the action and effect of the present invention can be effectively exhibited. The weight average molecular weight is preferably in a range of 200,000 to 800,000, more preferably in a range of 300,000 to 700,000. When the weight average molecular weight is 200,000 or more, it is excellent in that abrasion of the resin coating layer formed on the surface of the core material particles is not excessively promoted, and adhesion of the carrier particles is unlikely to occur. When the weight average molecular weight is 800000 or less, a reduction in charge amount due to migration of the external additive from the toner particles to the surface of the carrier particles is not caused, and a favorable charge amount can be maintained for a long period of time.

The weight average molecular weight is measured by gel permeation chromatography (GPC), and more specifically, may be measured by the following method.

An apparatus “HLC-8220GPC” (manufactured by Tosoh Corp.) and a column “TSK guard column SuperHZ-L+TSK gel Super HZM-M3 series” (manufactured by Tosoh Corporation) are used.

While the column temperature is maintained at 40° C., tetrahydrofuran (THF) as a carrier-solvent is flowed at a flow rate of 0.35 mL/min.

At room temperature, a measurement sample is dissolved in tetrahydrofuran to a concentration of 1 mg/mL under dissolution conditions in which the sample is treated for 10 minutes with a roller stirrer.

Next, the mixture is treated with a membrane filter having a pore size of 0.2 μm to obtain a sample solution. The sample solution (10 μL) is injected into the device together with the carrier solvent, and detection is performed using a refractive index detector (RI detector).

The weight average molecular weight distribution of the measurement sample is calculated using a calibration curve measured using monodisperse polystyrene standard particles. Ten points are taken in polystyrene for measuring the calibration curve.

### (Thickness of Resin Coating Layer)

The thickness of the resin coating layer is preferably in a range of 0.05 to 4 μm, more preferably in a range of 0.2 to 3 μm. When the thickness of the resin coating layer is in the above range, the chargeability and durability of the carrier particles can be improved. The thickness of the resin coating layer can be determined by the following method.

A measurement sample is prepared by cutting the carrier particles along a plane passing through the center of the particles using a focused ion beam apparatus “SMI2050” (manufactured by Hitachi High-Tech Corp.).

A cross section of the measurement sample is observed with a transmission type electron microscope “JEM-2010F” (manufactured by JEOL Ltd.) in a field of view at 5000× magnification. Thereafter, an average value of the part having the maximum thickness and the part having the minimum thickness in the field of view is defined as the thickness of the resin coating layer. The number of field of view for measurement is set to 5.

### (Resistance Adjuster)

The coating resin preferably contains at least one of carbon black, magnesium oxide, or titanium dioxide as a resistance adjuster, from the viewpoint of adjusting the static resistance value of the carrier coated with the coating resin. Among these, carbon black is particularly preferable because it is easily dispersed in the resin.

### (Exposed Area Ratio)

The charge of the carrier particles is also released through the core material particles exposed on the carrier surface. When the exposed area ratio of the core material particles is 10% or more, charges are appropriately released from the carrier particles, and thus excessive charging of the carrier particles can be suppressed. When the exposed area ratio is 18% or less, the resin coating the carrier particles is less likely to be peeled off and the carrier particles are less likely to deteriorate when friction occurs between the carrier particles to each other.

As described above, it is preferable that the exposed area ratio of the core material particles on the surface of the carrier particles is in a range of 10.0 to 18.0% based on the surface area of the core material particles from the viewpoint of suppressing excessive charging of the carrier particles and suppressing deterioration of the carrier particles.

The exposed area ratio of the core material particles on the surface of the carrier particles can be measured, for example, by the following method.

As a measurement device, “K-Alpha” (manufactured by Thermo Fisher Scientific) is used. The main element constituting the coating layer (usually carbon) and the main element constituting the core material particle (usually iron) are measured by XPS measurement (X-ray photoelectron spectroscopy measurement).

At this time, Al monochromatic X-rays are used as an X-ray source, an acceleration voltage is set to 7 kV, and an emission current is set to 6 mV.

Note that when the core material particles are iron oxide-based particles, Cis spectrum is measured for carbons. For iron, Fe2p3/2 spectrum is measured. For oxygen, O1s spectrum is measured.

The numbers of elements of carbon, oxygen, and iron (represented as “AC”, “AO”, and “AFe”, respectively) are obtained, and the iron amount ratio of the core material particles alone and the iron amount ratio of the carrier after the core material particles are coated with the coating layer are obtained by substituting them into the following Expression (2) based on the following formula from the obtained element number ratios of carbon, oxygen, and iron.

$$Iron amount ratio [ atomic \% ] = AFe / ( A C + A O + AFe ) \times 100 \qquad ( Expression 2 )$$

The coating ratio is obtained by substituting the iron amount ratio of the core material particle alone and the iron amount ratio of the carrier after coating the core material particles with the coating layer into the following Expression (3).

$$Coating ratio [ \% ] = \{ 1 - ( Iron amount ratio of carrier ) / ( Ir on amount ratio of core material particles alone ) \} \times 100 \qquad ( Expression 3 )$$

When a material other than the iron oxide-based material is used as the core material particles, the spectra of metal elements constituting the core material particles in addition to oxygen are measured, and the same calculation is performed according to the above Expressions to obtain the coating ratio.

### (Method for Producing Coating Resin)

The method for producing the coating resin is not particularly limited, and a conventionally known polymerization method can be appropriately used. Examples thereof include a pulverization method, an emulsion dispersion method, a suspension polymerization method, a solution polymerization method, a dispersion polymerization method, an emulsion polymerization method, an emulsion polymerization aggregation method, and other known methods. In particular, from the viewpoint of controlling the particle diameter, synthesis by an emulsion polymerization method is preferred.

The polymerization initiator other than the monomers used in the emulsion polymerization method, the surfactant, an optionally chain transfer agent, and the like are not particularly limited, and conventionally known ones can be used. The polymerization conditions such as polymerization temperature are also not particularly limited, and can be adjusted by appropriately using conventionally known polymerization conditions.

Specifically, it is desirable to perform emulsion polymerization using various additives shown in Examples described later. That is, it is desirable to perform emulsion polymerization of the above-described monomers by using sodium dodecyl sulfate as an anionic surfactant, water (ion exchanged water) as a solvent, and potassium persulfate (KPS) as a polymerization initiator, respectively, from the viewpoint of controlling the particle diameter.

### (1.2) Toner for Developing Electrostatic Charge Image

### (1.2.1) Toner Base Particles

The toner base particles constituting the toner for developing electrostatic charge image contained in the two-component developer according to the present invention contain, for example, a binder resin, and if necessary, a colorant. The toner base particles may further contain other components such as a release agent and a charge control agent as needed.

In the present invention, the term “toner particles” refers to toner base particles to which an external additive is added, and an aggregate of toner particles is referred to as a “toner”. In general, the toner base particles can be used as toner particles as they are, but in the present invention, toner particles obtained by adding an external additive to the toner base particles are used as toner particles. In the following description, the toner base particles and the toner particles are also simply referred to as “toner particles” when it is not particularly necessary to distinguish therebetween. The constituent materials of the toner base particles according to the present invention are described in detail below.

### (Binder Resin)

As the binder resin constituting the toner base particles, a thermoplastic resin is preferably used. As such a binder resin, those generally used as a binder resin constituting a toner can be used without particular limitation.

Examples thereof include a styrene resin, an acrylic resin, a styrene-acrylic copolymer resin, polyester, a silicone resin, an olefin-based resin, an amide resin, an epoxy resin, and a composite resin in which two or more of these resins are chemically bonded.

Among these, a styrene resin, an acrylic resin, a styrene-acrylic copolymer resin, and polyester are preferable because these resins have low viscosity and high sharp-melt properties in melting properties. These may be used singly or in combination of two or more.

In particular, it is preferable to contain a crystalline polyester from the viewpoint of easily dissolving toner particles and achieving energy saving at the time of fixing.

The term “crystalline” herein means having a clear endothermic peak, not a stepwise endothermic change in differential scanning calorimetry. The clear endothermic peak here specifically means a peak having a half-value width of the endothermic peak of 15° C. or lower when measured at the temperature increase rate of 10° C./min in differential scanning calorimetry (DSC) described in Examples.

The crystalline polyester has a moiety synthesized from a polyvalent carboxylic acid component and a polyvalent alcohol component. The crystalline polyester may be in the form of a composite resin in which the crystalline polyester is chemically bonded to another resin.

Examples of the polyvalent carboxylic acid components include aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, dodecanedioic acid (1,12-dodecanedicarboxylic acid), 1,14-tetradecanedicarboxylic acid, and 1,18-octadecanedicarboxylic acid.

Other examples include aromatic dicarboxylic acids such as phthalic acids, isophthalic acids, terephthalic acids, naphthalene-2,6-dicarboxylic acids, malonic acids, mesaconic acids, and other dibasic acids.

Further examples include, but are not limited to, anhydrides thereof and lower alkyl esters thereof.

These may be used singly or in combination of two or more.

Examples of trivalent or higher carboxylic acids include 1,2,4-benzenetricarboxylic acid, 1,2,5-benzenetricarboxylic acid, 1,2,4-naphthalenetricarboxylic acid, and anhydrides and lower alkyl esters thereof.

These may be used singly or in combination of two or more.

Furthermore, in addition to the polyvalent carboxylic acid component, a dicarboxylic acid component having a double bond may be used.

Examples of the dicarboxylic acid having a double bond include, but are not limited to, maleic acid, fumaric acid, 3-hexenedioic acid, and 3-octenedioic acid.

Further examples include lower esters and acid anhydrides of these.

As the polyvalent alcohol component, an aliphatic diol is preferable, and a linear aliphatic diol in which the number of carbon atoms of the main chain portion is in a range of 47 to 20 is more preferable.

When the aliphatic diol is a linear aliphatic diol, the crystallinity of the polyester is maintained and a decrease in the melting temperature is suppressed, and thus the toner blocking resistance, the image storability, and the low-temperature fixability become excellent.

When the number of carbon atoms is in the range of 4 to 20, the melting point at the time of condensation polymerization with the polyvalent carboxylic acid component is suppressed low and low-temperature fixing is achieved while the materials are practically easily available.

The number of carbon atoms of the main chain moiety is more preferably in a range of 4 to 14.

Examples of the aliphatic diols suitable for use in the synthesis of the crystalline polyester include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, and 1,18-octadecanediol.

These may be used singly or in combination of two or more.

Among these, in consideration of availability, 1,4-butanediol, 1,6-hexanediol, 1,8-octanediol, 1,9-nonanediol, and 1,10-decanediol are preferable.

Examples of trivalent or higher alcohols include glycerin, trimethylolethane, trimethylolpropane, and pentaerythritol.

These may be used singly or in combination of two or more.

The crystalline polyester may be synthesized according to usual methods by performing a polycondensation reaction of a polyvalent carboxylic acid component and a polyvalent alcohol component in the presence of a polymerization catalyst such as dibutyltin oxide, tetrabutoxy titanate, or the like.

The polycondensation reaction is preferably performed at a reaction temperature in a range of 180 to 230° C.

The inside of the reaction system is depressurized as necessary, and the reaction is performed while water or alcohol generated by polycondensation is removed.

When the monomer is not dissolved or compatible at the reaction temperature, a solvent having a high boiling point may be added as a solubilizing agent to dissolve the monomer.

The polycondensation reaction is performed while distilling off the solubilizing solvent.

When a monomer having poor compatibility is present in the copolymerization reaction, the monomer having poor compatibility and an acid or an alcohol to be polycondensed with the monomer may be preliminarily condensed and then polycondensed with the main component.

The weight average molecular weight of the crystalline polyester is preferably in a range of 5,000 to 50,000 from the viewpoint of good low-temperature fixability and image storability.

The weight average molecular weight of the crystalline polyester herein is a value measured by GPC, and can be measured under the same measurement conditions as for the coating resin of the carrier.

Examples of the polymerizable monomer for obtaining a binder resin other than the crystalline polyester (hereinafter, also referred to as “other resin”) include styrene monomers such as styrene, methylstyrene, methoxystyrene, butylstyrene, phenylstyrene, and chlorostyrene.

Other examples include acrylic acid ester monomers such as methyl acrylate, ethyl acrylate, n-butyl acrylate, 2-ethylhexyl acrylate, and n-stearyl acrylate.

Further examples include methacrylic acid ester monomers such as methyl methacrylate, ethyl methacrylate, n-butyl methacrylate, and 2-ethylhexyl methacrylate. Still other examples include carboxylic acid monomers such as acrylic acid, methacrylic acid, and fumaric acid. These polymerizable monomers may be used singly or in combination of two or more.

These other resins can be produced by a known method such as a suspension polymerization method, an emulsion polymerization method, or a dispersion polymerization method. Among them, the emulsion polymerization method is preferable from the viewpoint of controlling the particle diameter. When the other resin is produced by an emulsion polymerization method, for example, a radical polymerization initiator, a chain transfer agent, and the like are used.

Examples of the radical polymerization initiator include persulfates such as potassium persulfate and ammonium persulfate, water-soluble azo compounds such as 4,4′-azobis(4-cyanovaleric acid) and 2,2′-azobis(2-amidinopropane)hydrochloride, and hydrogen peroxide.

The above-described radical polymerization initiator can also be used as a redox polymerization initiator as desired, and these can also be used in combination.

Examples of the combination include combinations of a persulfate and sodium metabisulfite or sodium sulfite, and hydrogen peroxide and ascorbic acid.

Examples of the chain transfer agent include thiol compounds such as n-dodecyl mercaptan, tert-dodecyl mercaptan, and n-octyl mercaptan. Other examples include halogenated methanes such as tetrabromomethane and tribromochloromethane.

The weight average molecular weight of the other resin is preferably in a range of 10,000 to 50,000 from the viewpoints of low-temperature fixability and image storability.

The weight average molecular weight of the other resin is a value measured by GPC, and can be measured under the same measurement conditions as for the coating resin.

### (External Additive)

To the surface of the toner base particles according to the present invention, an external additive is adhered for the purpose of controlling fluidity and chargeability. As the external additive, conventionally known metal oxide particles can be used.

Examples thereof include silica particles, titania particles, alumina particles, zirconia particles, zinc oxide particles, chromium oxide particles, cerium oxide particles, antimony oxide particles, tungsten oxide particles, tin oxide particles, tellurium oxide particles, manganese oxide particles, boron oxide particles, strontium titanate particles, calcium titanate particles, and magnesium titanate particles.

These may be used singly or in combination of two or more.

Specifically for the silica particles, silica particles prepared by a sol-gel method are more preferably used. The silica particles produced by a sol-gel method have a feature that the particle diameter distribution is narrow, and thus are preferable from the viewpoint of suppressing the variation in adhesion strength.

The silica particles formed by a sol gel method preferably have a number-average primary particle diameter in a range of 55 to 150 nm. The silica particles having a number average primary particle diameter in such a range have a particle diameter larger than those of other external additives and thus serve as a spacer. The silica particles have then an effect of preventing other external additives having a small particle diameter from being embedded in the toner base particles by being stirred and mixed therewith in a developing device. Such silica particles also have an effect of preventing toner base particles from fusing together.

The number-average primary particle diameter of the metal-oxide particles other than the silica particles produced by a sol gel method is preferably in a range of 10 to 70 nm, more preferably in a range of 10 to 40 nm.

The number average primary particle diameter of the metal oxide particles can be measured, for example, by a method of determining the diameter from an image taken by a scanning electron microscope.

Alternatively, organic fine particles of a homopolymer of styrene, methyl methacrylate, or the like, a copolymer of any of these, or the like may be used as an external additive, or organic-inorganic composite fine particles in which any of the aforementioned polymers and inorganic fine particles are combined may be used.

The surface of the metal oxide particles used as the external additive is preferably subjected to a hydrophobic treatment with a known surface treatment agent such as a coupling agent.

As the surface treatment agent, dimethyldimethoxysilane, hexamethyldisilazane (HMDS), methyltrimethoxysilane, isobutyltrimethoxysilane, decyltrimethoxysilane and the like are preferable.

Silicone oil can also be used as the surface treatment agent. Specific examples of the silicone oil include cyclic compounds such as organosiloxane oligomer, octamethylcyclotetrasiloxane, decamethylcyclopentasiloxane, tetramethylcyclotetrasiloxane, and tetravinyltetramethylcyclotetrasiloxane, and linear or branched organosiloxanes.

In addition, a highly reactive silicone oil in which a modifying group is introduced into a side chain, one end, both ends, one end of a side chain, both ends of a side chain, or the like and at least the end is modified may be used.

Examples of the modifying group include, but are not particularly limited to, an alkoxy group, a carboxyl group, a carbinol group, a higher fatty acid-modified group, a phenol group, an epoxy group, a methacryl group, and an amino group.

Silicone oil having several kinds of modifying groups such as amino/alkoxy modification may also be used. Furthermore, mixed or combination treatments may be performed using dimethyl silicone oil and the above-described modified silicone oil, and further using other surface treating agents.

Examples of the treatment agent used in combination include a silane coupling agent, a titanate coupling agent, an aluminate coupling agent, various silicone oils, a fatty acid, a fatty acid metal salt, an ester thereof, and a rosin acid.

A lubricant can also be used as the external additive to further improve the cleaning performance and the transferability.

Specific examples of the lubricant include salts of higher fatty acids such as zinc stearate and calcium stearate and boron nitride. The amount of the external additive to be added is preferably in a range of 0.1 to 10% by mass, more preferably in a range of 1 to 5% by mass based on the total amount of the toner particles.

### (Release Agent)

The toner particles may contain a release agent.

The release agent is not particularly limited, and examples thereof include known release agents, for example, hydrocarbon waxes such as polyethylene wax, oxidized polyethylene wax, polypropylene wax, oxidized polypropylene wax, and Fischer-Tropsch wax, carnauba wax, fatty acid ester wax, Sasol wax, rice wax, candelilla wax, jojoba oil wax, and beeswax.

The content of the release agent in the toner particles is preferably in a range of 1 to 30 parts by mass, more preferably in a range of 5 to 20 parts by mass, with respect to 100 parts by mass of the binder resin.

### (Charge Control Agent)

The toner particles may contain a charge control agent.

Examples of the charge control agent include a metal complex of a salicylic acid derivative with zinc or aluminum (salicylic acid metal complex), a calixarene compound, an organic boron compound, and a fluorine-containing quaternary ammonium salt compound.

The content of the charge control agent in the toner particles is preferably in a range of 0.1 to 5 parts by mass with respect to 100 parts by mass of the binder resin.

### (Colorant)

The toner particles according to the present invention may further contain a colorant to make a color toner. Examples of the colorant that can be used include known inorganic or organic coloring agents. Specific colorants are shown below.

Examples of colorants for black include carbon blacks such as furnace black, channel black, acetylene black, thermal black, and lamp black, and magnetic powders such as magnetic and ferrite.

Examples of colorants for magenta or red include C. I. Pigments Red 2, 3, 5, 6, 7, 15, 16, 48:1, 48:2, 48:3, 53:1, 57:1, 60, 63, 64, 68, 81, 83, 87, 88, 89, 90, 112, 114, 122, 123, 139, 144, 149, 150, 163, 166, 170, 177, 178, 184, 202, 206, 207, 209, 222, 238, and 269.

Examples of colorants for orange or yellow include C. I. Pigments Orange 31 and 43, and C. I. Pigments Yellow 12, 14, 15, 17, 74, 83, 93, 94, 138, 155, 162, 180, and 185.

Examples of colorants for green or cyan include C. I. Pigments Blue 2, 3, 15, 15:2, 15:3, 15:4, 16, 17, 60, 62, and 66, and C. I. Pigment Green 7.

Examples of dyes include C. I. Solvents Red 1, 49, 52, 58, 63, 111, and 122, C. I. Solvents Yellow 2, 6, 14, 15, 16, 19, 21, 33, 44, 56, 61, 77, 79, 80, 81, 82, 93, 98, 103, 104, 112, and 162, and C. I. Solvents Blue 25, 36, 60, 70, 93, and 95.

These colorants may be used singly or in combination of two or more, if necessary.

When a colorant is used, the amount of the colorant to be added is preferably in a range of 1 to 30% by mass, more preferably in a range of 2 to 20% by mass based on the entire toner.

As the colorant, a surface-modified colorant may also be used.

As the surface modifier in this case, conventionally known surface modifiers can be used, and specifically, a silane coupling agent, a titanium coupling agent, an aluminum coupling agent, or the like can be preferably used.

### (Others)

### [Volume Average Particle Diameter]

The volume average particle diameter of the toner particles according to the present invention is in a range of 3 to 10 μm. When the volume average particle diameter is less than 3 μm, the fluidity of the toner particles decreases, and the rise of the charge amount of the toner particles decreases. When the volume average particle diameter is more than 10 μm, deterioration in image quality occurs. The volume average particle diameter of the toner particles is preferably in a range of 3.5 to 6.5 μm.

As the volume average particle diameter of the toner particles, specifically, a volume-based median diameter (D₅₀) measured by the following method is adopted.

The volume-based median diameter (D₅₀) of the toner particles can be measured and calculated using an apparatus in which a computer system for data processing is connected to “Multisizer 3 (manufactured by Beckman Coulter, Inc.)”.

The measurement procedure is as follows: 0.02 g of toner particles are wetted with 20 mL of a surfactant solution, and then subjected to ultrasonic dispersion for 1 minute to prepare a toner particle dispersion.

As the surfactant solution, for example, a surfactant solution obtained by diluting a neutral detergent containing a surfactant component with pure water by a factor of 10 can be used for the purpose of dispersing toner particles.

The toner particle dispersion is poured into a beaker containing ISOTON II (manufactured by Beckman Coulter, Inc.) in a sample stand with a pipette until the measured concentration falls in a range of 5 to 10%, and the measurement is performed with setting the count of the measuring machine to 25000.

The Multisizer 3 used has an aperture diameter of 100 μm.

The range in the measurement range of 1 to 30 μm is divided into 256 parts to calculate the frequency, and the particle diameter at which the volume integrated fraction is 50% from the largest is defined as the volume-based median diameter (D₅₀).

The volume average particle diameter of toner particles can be controlled by controlling the concentration of the aggregating agent, the addition amount of the organic solvent, the fusion time, or the like in the production method described above.

### [Average Circularity]

The average circularity of the toner particles according to the present invention is preferably 0.98 or less, more preferably 0.930 to 0.975 or less.

Toner particles having an average circularity in such a range are more easily charged.

The average circularity can be measured using, for example, a flow-type particle image analyzer “FPIA-3000” (manufactured by SYSMEX CORPORATION), and specifically, can be measured by the following method.

The toner particles are wetted with an aqueous surfactant solution, ultrasonically dispersed for 1 minute, and then measured with the “FPIA-3000” under measurement conditions of a HPF (high magnification imaging) mode at an appropriate concentration of a HPF detection number of 3,000 to 10,000. Within this range, a reproducible measurement value can be obtained. The circularity is calculated by the following Expression (5).

$$Circularity = \qquad Expression ( 5 )$$

$$( Perimeter of circle having the same projected area as particle image ) / ( Perimeter of particle projection image )$$

The average circularity is an arithmetic average value obtained by adding up the circularities of the respective particles and dividing the sum by the total number of the measured particles.

The average circularity of toner particles can be controlled by controlling the temperature, time, and the like during the aging treatment in the production method described above.

### (1.2.2) Method for Producing Toner

The toner base particles according to the present invention, that is, the particles at the stage before the addition of the external additive, can be produced by a known toner production method.

That is, examples of the toner production method include a so-called pulverization method in which toner base particles are prepared through kneading, pulverization, and classification steps, and a so-called polymerization method in which a polymerizable monomer is polymerized, and at the same time, particle formation is performed while controlling the shape and size.

Toner particles are produced by adding an external additive to and mixed with the toner base particles.

As a mixing device for the external additive, various known mixing devices such as a Turbula mixer, a Henschel mixer, a Nauter mixer, and a V-type mixer can be used.

For example, when a Henschel mixer is used, the circumferential speed of the tip of the stirring blade is preferably set in a range of 30 to 80 m/s, and stirring and mixing are performed for about 10 to 30 minutes in a range of 20 to 50° C.

### 2. Photoreceptor

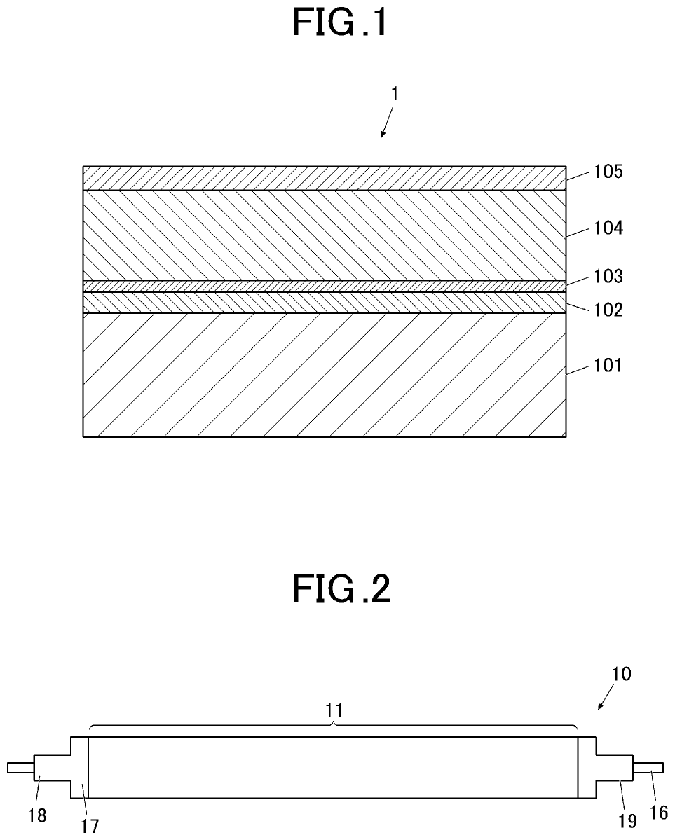

The “photoreceptor” is a member that bears a latent image or a visible image on a surface thereof in an electrophotographic image forming method. The photoreceptor according to the present invention is composed from, for example, a support, a photosensitive layer, a protective layer, and other layers. FIG. 1 illustrates an example of a layer structure of an electrophotographic photoreceptor according to the present invention.

In image formation, first, the surface of the photoreceptor is charged to generate a potential difference between the surface of the photoreceptor and the surface of the support. Next, charges are generated from the photosensitive layer by an exposure device, and the charges cancel out charges on the surface of the photoreceptor, whereby an electrostatic latent image is formed on the surface of the photoreceptor. Subsequently, a developing bias voltage is applied to a developer bearing member, whereby the toner is electrostatically attracted from the developer bearing member to the latent image portion on the surface of the photoreceptor, and the latent image is developed.

Here, when a convex portion having a certain size or larger is present on the surface of the photoreceptor, an electric field is likely to be concentrated on the convex portion, and thus charge leakage occurs between the surface of the support and the outermost surface of the photoreceptor when the outermost surface of the photoreceptor is charged.

The absolute value of the potential of the portion of the surface of the photoreceptor where the charge has leaked is reduced, whereby the toner is easily attracted to the portion where the charge has leaked.

The portion to which the toner is easily attracted causes an image defect called “black spot” when the toner is transferred and fixed to a recording medium.

To inhibit the leakage of charge from the surface of the photoreceptor according to the present invention, it is effective to set the absolute value of the potential difference between the outermost surface of the photoreceptor and the support to be small.

However, when the absolute value of the potential difference is set small, the toner is also attracted to a non-image portion on the outermost surface of the photoreceptor, and so-called image fogging occurs.

Here, the “non-image portion” refers to a portion of the recording medium where an image is not originally intended to be formed.

The “image fogging” refers to formation of a toner image in a non-image portion.

To prevent such image fogging, it is effective to set an absolute value of a voltage to be applied in development to be small. However, in this case, the toner is difficult to separate from the photoreceptor, and particularly in a low-temperature and low-humidity environment in which the toner charge amount tends to increase, the image density may decrease.

When the above-described carrier having a static resistance value in the range of 10⁸ to 10¹² Ω·cm is used in the two-component developer, the increase in the charge amount of the toner can be prevented, and the decrease in the image density as described above can be suppressed.

### (2.1) Support

The support of the photoreceptor according to the present invention is an electrically conductive support and is made of an aluminum alloy.

### (Silicon Content)

The silicon content in the aluminum alloy described above is in a range of more than 0.6% by mass and 12.6% by mass or less.

The aluminum alloy may contain an element other than silicon, and examples of the element include copper, chromium, nickel, and zinc.

When the content of silicon in the aluminum alloy is 0.6% by mass or less, the processability is deteriorated, so that the surface of the photoreceptor becomes non-uniform. When the silicon content in the aluminum alloy is more than 12.6 mass, coarse crystals (convex portions) due to the eutectic crystal of silicon and aluminum are likely to be generated, which is likely to cause image failure such as black spots.

From the viewpoint of the processability of the surface of the support of the photoreceptor, the silicon content in the aluminum alloy is more preferably more than 0.8% by mass.

### [Measurement Method]

The silicon content in the aluminum alloy is obtained by measuring the amount of the silicon element, and the amount of the silicon element can be measured by, for example, high-frequency inductively coupled plasma emission spectrometry (Inductively Coupled Plasma).

The “high-frequency inductively coupled plasma emission spectrometry” is a method in which a solution sample obtained by dissolving a metal in an acid, an alkali, or the like is sprayed into Ar plasma, the excited and emitted light is separated into each wavelength, and the type and content of elements are quantified from the light intensity.

In this method, the light intensity and the content are in a linear relationship from a trace amount region to a high concentration, and each element can be analyzed simultaneously.

As a measurement device for the high-frequency inductively coupled plasma emission spectrometry, for example, “ULTIMA2000 (manufactured by Horiba, Ltd.)” can be used.

In addition, an emission spectrometer with an argon atmosphere discharge emission stand, an emission spectrometer with an atmosphere discharge emission stand, a glow discharge mass spectrometer (GD-MS), an X-ray fluorescence spectrometer (XRF), and the like can also be used.

When a coating layer such as a resin exists on the support of the photoreceptor according to the present invention, the measurement is performed after the coating layer such as a resin is appropriately removed with a solvent or the like.

### (2.2) Photosensitive Layer

The photosensitive layer is a layer for forming an electrostatic latent image of a desired image on the surface of the photoreceptor by an exposure means described later. The photosensitive layer may be a single layer or may be formed of a plurality of stacked layers. Preferable examples of the photosensitive layer include a single layer containing a charge transport substance and a charge generation substance, and a laminate of a charge transport layer containing a charge transport substance and a charge generation layer containing a charge generation substance.

### (2.3) Protective Layer

The protective layer is a layer for improving the mechanical strength of the surface of the photoreceptor and improving scratch resistance and abrasion resistance. Preferable examples of the protective layer include a layer containing a polymerized and cured product of a composition containing a polymerizable monomer.

### (2.4) Other Layers

The photoreceptor may further include other layers in addition to the conductive support, the photosensitive layer, and the protective layer described above.

### (2.4.1) Intermediate Layer

Preferred examples of other layers include an intermediate layer.

The intermediate layer is, for example, a layer that is disposed between the conductive support and the photosensitive layer and has a barrier function and an adhesive function.

### (2.4.2) Outermost Layer

The outermost layer of the photoreceptor herein refers to a layer disposed at the outermost portion on the side contacting with a toner. The outermost layer is not particularly limited, but is preferably the above-described protective layer.

In the photoreceptor according to the present invention, the outermost layer preferably contains inorganic particles, and more preferably, the inorganic particles are surface-treated with a surface treatment agent. Examples of the surface treatment agent include a silane coupling agent, an electron transport compound, and a compound having a polymerizable functional group.

### (Inorganic Particles)

The inorganic particles are not particularly limited, and examples thereof include titanium oxide, zinc oxide, alumina (aluminum oxide), silica (silicon oxide), tin oxide, antimony oxide, indium oxide, bismuth oxide, magnesium oxide, lead oxide, tantalum oxide, yttrium oxide, cobalt oxide, copper oxide, manganese oxide, selenium oxide, iron oxide, zirconium oxide, germanium oxide, niobium oxide, molybdenum oxide, vanadium oxide, tin-doped indium oxide, antimony-doped tin oxide and zirconium oxide, and copper-aluminum composite oxide (CuAlO₂).

The inorganic particles preferably contain at least one of tin, zinc, titanium, silicon, and copper, more preferably contain at least one of tin, zinc, titanium, and copper, and particularly preferably contain at least one of tin, zinc, and copper.

The number average primary particle diameter of the inorganic particles is not particularly limited, but is preferably in a range of 5 to 300 nm, more preferably in a range of 10 to 200 nm.

The number average primary particle diameter of the inorganic particles can be calculated from an average value of major axes of particle images observed with a scanning electron microscope.

### (Binder Resin)

The outermost layer (protective layer) may contain a binder resin.

As the binder resin for the outermost layer, a known binder resin can be used singly or two or more resins can be used in combination.

### (2.5) Method for Producing Photoreceptor

The photoreceptor according to the present invention can be produced by a known method for producing an electrophotographic photoreceptor. The outermost layer is preferably produced by a method including the steps of applying an outermost layer-forming application liquid containing inorganic particles to the surface of a photosensitive layer formed on an aluminum alloy support, and irradiating the applied outermost layer-forming application liquid with active energy rays or heating the applied outermost layer-forming application liquid to obtain a cured product of the outermost layer-forming composition.

### (Others)

The thickness of the outermost layer is preferably in a range of 1 to 10 μm, more preferably in a range of 1.5 to 5 μm.

### 3. Developer Bearing Member

The silicon content in the aluminum alloy forming the developing sleeve in the developer bearing member according to the present invention is in a range of more than 0.6% by mass and 12.6% by mass or less.

When a convex portion of a certain size or larger is present on the surface of the developer bearing member, charge leakage occurs between the convex portion and the surface of the photoreceptor during toner image formation on a recording medium.

Due to the occurrence of such charge leakage, the absolute value of the potential of the surface of the photoreceptor is partially reduced, whereby the toner is easily attracted to the portion where the charge has leaked.

The portion to which the toner is easily attracted causes an image defect called “black spot” when the toner is transferred and fixed to a recording medium.

To inhibit leakage of charge from the surface of the developer bearing member according to the present invention, it is necessary to set the absolute value of the potential at the time of applying the developing bias voltage to be small.

However, when the absolute value of the potential at the time of application of the development bias voltage is set to be small, the toner is difficult to separate from the photoreceptor, and thus, particularly in a low-temperature and low-humidity environment in which the toner charge amount tends to increase, the image density may decrease.

When the above-described carrier having a static resistance value in the range of 10¹ to 10¹¹ Ω·cm is used in the two-component developer, the increase in the charge amount of the toner can be prevented, and the decrease in the image density as described above can be suppressed.

### (Configuration of Developer Bearing Member)

The developer bearing member according to the present invention is composed of, for example, a developing sleeve, a flange, a shaft and a magnet roller.

The “developing sleeve” is a means having a function of bearing an appropriately charged developer and supplying the developer to a photoreceptor on which an electrostatic latent image is formed, and is, for example, a part of a developer bearing member of a developing device included in an electrophotographic image forming apparatus.

Furthermore, the above-described developing sleeve does not include a pipe or the like which is not a simple cylindrical shape but has lotus root-like holes in a cross section as show in JP 2003-91084A.

FIG. 2 is an external view of a developer bearing member.

For example, the developing sleeve 11 in FIG. 2 is rotatable and cylindrical, and plays a role of bearing and conveying the developer on the surface thereof.

The surface of the developing sleeve 11 is not limited to the configuration as illustrated in FIG. 2, and for example, grooves or the like may be formed on the surface.

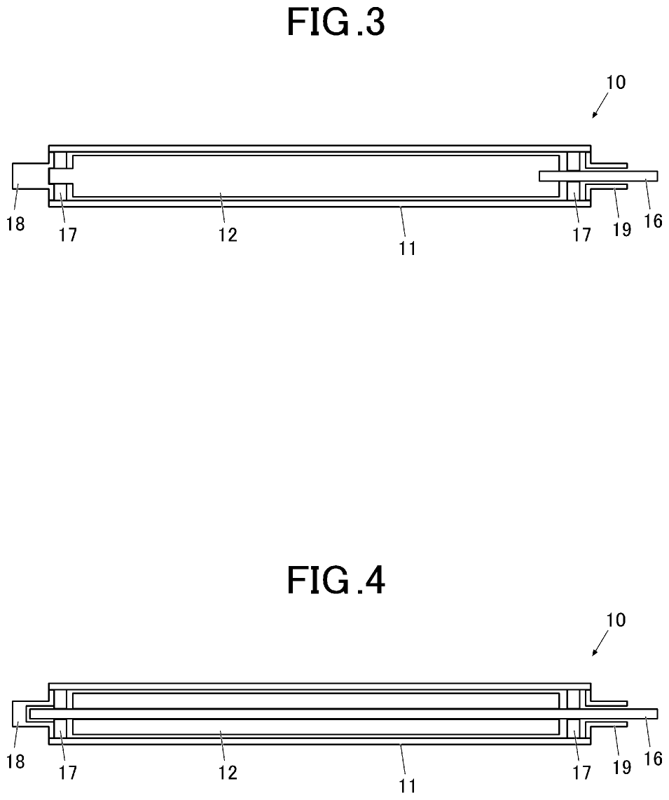

FIGS. 3 and 4 are axial cross-sectional views of developer bearing members which are an example of the developer bearing member of the present invention and which include magnet rollers and shafts having different shapes.

The developer bearing member according to the present invention, however, may not include a magnet portion such as a magnet roller, and is not limited to the configurations of FIGS. 3 and 4.

FIG. 3 is a cross-sectional view of a developer bearing member having a configuration in which a shaft does not penetrate a magnet roller.

As illustrated in FIG. 3, the developer bearing member 10 fixes a shaft 16 by inserting the shaft into a hole formed in the magnet roller 12, and includes the developing sleeve 11 of a non-magnetic material on an outer periphery of the magnet roller 12.

FIG. 4 is a cross-sectional view of the developer bearing member having a configuration in which a shaft penetrates a magnet roller.

As illustrated in FIG. 4, the developer bearing member 10 includes the magnet roller 12 fixed around the shaft 16, and the developing sleeve 11 that is made of a non-magnetic material and is provided on an outer periphery of the magnet roller 12.

The developing sleeve 11 is connected to the magnet roller 12 with a predetermined gap therebetween via a bearing part 17, such as a bearing, provided outside the magnet roller 12.

On the outside of the bearing part 17 in the axial direction of the developing sleeve 11, a non-driving side flange 18 and a driving side flange 19 are connected to the developing sleeve 11.

The non-driving side flange 18 and the driving side flange 19 may be reversed, and the present invention is not limited thereto.

The non-driving side flange 18 and the driving side flange 19 are rotationally driven together with the developing sleeve 11 while being held with respect to the developing container.

### (Silicon Content)

The silicon content in the aluminum alloy forming the developing sleeve according to the present invention is in a range of more than 0.6% by mass and 12.6% by mass or less. When the content of silicon in the aluminum alloy is 0.6% by mass or less, the processability is deteriorated, so that the surface of the developer bearing member becomes non-uniform and unevenness occurs in an image. When the silicon content in the aluminum alloy is more than 12.6 mass, coarse crystals (convex portions) due to the eutectic crystal of silicon and aluminum are likely to be generated while the strength is increased. Thus, charge leakage tends to occur between the developing sleeve and the photoreceptor, and black spots occur.

From the viewpoint of the processability of the surface of the developing sleeve according to the present invention, the silicon content in the aluminum alloy is more preferably more than 0.8% by mass.

### [Measurement Method]

The method for measuring the silicon content in the aluminum alloy is the same as the method for measuring the silicon content in the aluminum alloy in the support of the photoreceptor described above.

### (Surface)

From the viewpoint of imparting appropriate roughness to the surface of the developing sleeve included in the developer bearing member, it is preferable to perform sandblasting, and thereby the roughness of the outer peripheral surface of the developing sleeve can be appropriately maintained.

### 4. Image Forming Method

The image forming method of the present invention is an image forming method using: a two-component developer; and an image forming apparatus comprising at least one of a photoreceptor including a support made of an aluminum alloy or a developer bearing member including a developing sleeve made of an aluminum alloy, wherein a static resistance value of a carrier contained in the two-component developer is in a range of 10¹ to 10¹¹ Ω·cm, and a silicon content in the aluminum alloy forming at least the support of the photoreceptor or the developing sleeve of the developer bearing member is in a range of more than 0.6% by mass and 12.6% by mass or less. The method can be suitably used for the image forming system of the present invention.

### 5. Image Forming Apparatus

In the image forming method of the present invention, for example, the following image forming apparatus can be used. The image forming apparatus includes a charging means, an exposure means, a developing means, and a transfer means. The image forming apparatus includes one or both of the above-described photoreceptor and developer bearing member.

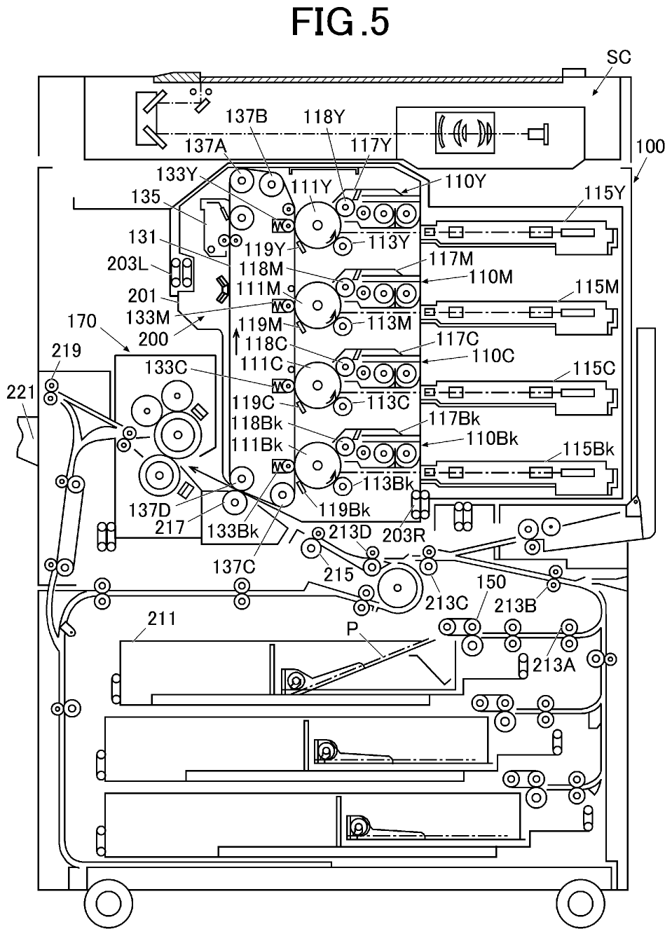

FIG. 5 is an explanatory cross-sectional view which shows an example of the configuration of the image forming apparatus according to the present invention. An image forming apparatus 100 illustrated in FIG. 5 is called a tandem-type color image forming apparatus, and includes four image forming units 110Y, 110M, 110C, and 110Bk, a sheet feed conveyance means 150, and a fixing means 170.

At an upper part of the main body of the image forming apparatus 100, a document image reading device SC is arranged.

The image forming units 110Y, 110M, 110C, and 110Bk are arranged side by side in the vertical direction.

The image forming units 110Y, 110M, 110C, and 110Bk include rotating drum-shaped photoreceptors 111Y, 111M, 111C, and 111k, charging units 113Y, 113M, 113C, and 113Bk positioned sequentially along the rotation direction of the photoreceptors in the outer peripheral surface region thereof, exposure means 115Y, 115M, 115C, and 115Bk, developing means 117Y, 117M, 117C, and 117Bk, primary transfer rollers (primary transfer means) 133Y, 133M, 133C, and 133Bk, and cleaning means 119Y, 119M, 119C, and 119Bk.

The photoreceptor includes a support made of an aluminum alloy, and the silicon content in the aluminum alloy is more than 0.6% by mass and 12.6% by mass or less.

Yellow (Y), magenta (M), cyan (C), and black (Bk) toner images are formed on the photoreceptors 111Y, 11M, 111C, and 111Bk, respectively.

Hereinafter, an example of the image forming unit 110Y will be described with reference to the drawings.

### <Charging Means>

The charging means is a means that uniformly charges the surface of the photoreceptor.

The charging means includes a contact type such as a charging roller, a charging brush and a charging blade, and a non-contact type such as a corona charging device (corotron charging device, scorotron charging device and the like). The contact method is advantageous in that the amount of harmful ozone gas generated in the charging process is small. The non-contact method is not a proximity discharge compared with the contact method and has an advantage that filming is less likely to occur.

The charging means included in the image forming system of the present invention may be of a contact type or a non-contact type.

The charging means is preferably a proximity charging roller or a contact charging roller from the viewpoint that the amount of harmful ozone gas generated in the charging process is small and that it is advantageous for achieving higher image quality and downsizing of the apparatus.

The charging means 113Y illustrated in FIG. 5 is of a contact type. The charging means 113Y in this example is composed of a charging roller disposed in contact with the 111Y of the photoreceptor and a power source for applying a voltage to the charging roller.

### <Exposure Means>

The exposure means performs exposure on the photoreceptor to which the uniform potential is applied by the charging means based on the image signal and forms an electrostatic latent image corresponding to an image.

Examples of the exposure means include an exposure means including an LED in which light emitting elements are arranged in an array in the axial direction of the photoreceptor and an image forming element, and an exposure means of a laser optical system.

### <Developing Means>

The developing means (developing device) is a means for supplying a developer to the surface of the photoreceptor and developing the electrostatic latent image formed on the surface of the photoreceptor to form a toner image.

Note that as the above-described developer, a developer containing the above-described toner and carrier is used.

The static resistance value of the carrier is in a range of 10⁸ Ω·cm or more and less than 10¹² Ω·cm.

The developing means may be provided with a lubricant supplying means for supplying a lubricant to the developer, and the developer supplied by the developing means preferably contains a lubricant from the viewpoint of improving abrasion resistance.

The lubricant is more preferably a metal soap from the viewpoint of improving abrasion resistance.

The developing means 117Y illustrated in FIG. 5 is, to be specific, composed of a developer bearing member 118Y which has a built-in magnet roller and rotates while holding a developer, a photoreceptor 111Y, and a voltage application device (not illustrated) which applies DC and/or AC bias voltage between the photoreceptor 111Y and the developer bearing member 118Y.

Note that the above-described developer bearing member is composed of the developing sleeve, the flange, the shaft, and the magnet roller as described above.

The silicon content in the aluminum alloy of the developing sleeve is in a range of more than 0.6% by mass and 12.6% by mass or less.

The developer is conveyed to the photoreceptor 111Y by the rotation of the developer bearing member 118Y. Next, the thin toner layer on the developer bearing member 118Y comes into contact with the photoreceptor 111Y and develops the electrostatic latent images on the photoreceptor 111Y.

The developer bearing member 118Y is connected to a voltage application device. By this voltage application device, a DC and/or AC bias voltage is applied to the developer bearing member 118Y. The developing bias can be adjusted to a desired value by controlling the voltage applied to the developer bearing member 118Y.

Due to a potential difference (developing potential difference) between the potentials of the electrostatic latent images borne by the developer bearing member 118Y and the photoreceptor 111Y, an electric field is formed in a developing section where the developer bearing member 118Y and the photoreceptor 111Y face to each other.

The toner in the developer conveyed to the developing section by the rotation of the developer bearing member 118Y moves by the action of the power received from the electric field, and is attracted to the electrostatic latent image on the photoreceptor 111Y.

When the electrostatic latent image carried on the photoreceptor 111Y is visualized, the toner image corresponding to the shapes of the electrostatic latent image is formed on the surface of the photoreceptor 111Y.

### [Developing Potential Difference]

The “developing potential difference” is a difference between a potential (Vi) of an image portion and a developing potential (Vdc).

It is preferable that the absolute value of the developing potential difference is in a range of 200 to 600 V, more preferably in a range of 300 to 400 V, from the viewpoint of achieving both of ensuring of the image density and suppression of the fogging.

### <Transfer Means>

The transfer means is a means for transferring a toner image onto a recording medium. As the transfer means, for example, a corona transfer device using corona discharge, a transfer belt, a transfer roller, or the like can be used. When an intermediate transfer member is used, a primary transfer roller serves as a transfer means.

The primary transfer roller 133Y shown in FIG. 5 transfers the toner image formed on the photoreceptor 111Y to an intermediate transfer body 131 in the form of an endless belt. The primary transfer roller 133Y is disposed in contact with the intermediate transfer body 131.

The image forming apparatus 100 illustrated in FIG. 5 employs an intermediate transfer method in which toner images formed on the photoreceptors 111Y, 111M, 111C, and 111Bk are transferred to an intermediate transfer member 131 by primary transfer rollers (primary transfer means) 133Y, 133M, 133C, and 133Bk, and each toner image transferred to the intermediate transfer member 131 is transferred to a transfer material P by a secondary transfer roller (secondary transfer means) 217, but may employ a direct transfer method in which the toner images formed on the photoreceptors are directly transferred to the transfer material P by a transfer means.

### Examples

Hereinafter, the present invention will be specifically described with reference to Examples, but the present invention is not limited thereto. In Examples, “part(s)” or “%” means “part(s) by mass” or “% by mass” unless otherwise specified.

### A. Production of Each Photoreceptor

### (A.1) Production of Photoreceptor 1

A photoreceptor 1 was produced according to the following procedure.

### (Preparation of Conductive Support)

A conductive support formed of an aluminum alloy was prepared.

The content of silicon based on the total amount of the aluminum alloy is 0.7% by mass.

Note that the conductive support has an outer shape of 30 mm and a length of 360 mm.

### (Formation of Intermediate Layer)

Next, an application liquid for forming an intermediate layer was prepared by dispersing the following component [1] in the following amounts.

<Component [1]>

| | |
|---|---|
| Polyamide resin | 1.0 parts by mass |
| Titanium oxide | 1.1 parts by mass |
| Ethanol | 15 parts by mass |

At this time, a sand mill was used as a dispersing machine of the component [1], and the dispersion was performed batchwise for 10 hours.

The polyamide resin of the component [1] used as the binder resin is “X1010” (manufacture by Daicel-Degussa Ltd.).

The titanium oxide of the component [1] used as the conductive particles is “SMT500SAS” (manufactured by TAYCA CORPORATION), and the number-average primary particle diameter thereof is 0.035 μm.

An application liquid for forming an intermediate layer prepared by dispersing the component [1] was applied to the outer peripheral surface of the conductive support by a dip coating method, and dried in an oven at 110° C. for 20 minutes.

Thus, a 2 μm-thick intermediate layer was formed on the surface of the conductive support.

### (Formation of Charge Generation Layer)

Next, an application liquid for forming a charge generation layer was prepared by mixing the following component [Ω] in the following amounts.

<Component [2]>

| | |
|---|---|
| Mixed crystal of adduct A and | 24 parts by mass |
| charge generation substance | |
| Polyvinyl butyral resin | 12 parts by mass |
| Mixed liquid A | 400 parts by mass |

The charge generation substance of the component [Ω] is titanyl phthalocyanine having clear peaks at 8.3°, 24.7°, 25.1°, and 26.5° in Cu-Kα characteristic X-ray diffraction spectrum measurement.

The adduct A of the component [Ω] is a compound obtained by adding (2R,3R)-2,3-butanediol to the charge generation substance (titanyl phthalocyanine described above) at a ratio of 1:1.

The polyvinyl butyral of the component [Ω] is “S-LEC BL-1” (manufactured by SEKISUI CHEMICAL CO., LTD.) (“S-LEC” is a registered trademark of the company).

The mixed liquid A of the component [Ω] is 3-methyl-2-butanone/cyclohexanone=4/1 (V/V).

At this time, as the mixer of the component [Ω], a circulation type ultrasonic homogenizer “RUS-600TCVP” (manufactured by NIHONSEIKI KAISHA LTD.) was used under the following conditions.

### <Conditions>

Dispersion is performed for 0.5 hours with setting the number of oscillations of the circulatory ultrasonic homogenizer to 19.5 kHz, the power to 600 W, and the circulatory flow rate to 40 L per hour.

An application liquid for a charge generation layer prepared by mixing the component [Ω] was applied to the surface of the intermediate layer by a dip coating method, and dried in an oven at 120° C. for 1 hour.

Thus, a 0.3 μm-thick charge generation layer was formed on the surface of the intermediate layer.

### (Formation of Charge Transport Layer)

An application liquid [A1] for a charge transport layer was prepared by mixing and dissolving the following components [3] in the following amounts.

<Component [3]>

| | |
|---|---|
| Charge transport substance (CTM-1) | 75 parts by mass |
| Polycarbonate | 100 parts by mass |
| Antioxidant | 4 parts by mass |

A chemical structural formula of the charge transport substance CTM-1 of the component [3] is shown below.

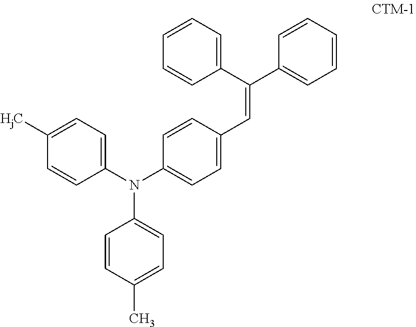

The polycarbonate of the component [3] is “Z300” (manufactured by Mitsubishi Gas Chemical Company, Inc.).

The antioxidant of the component [3] is “IRGANOX1010” (manufactured by BASF SE, “IRGANOX” is a registered trademark of the company).

The application liquid [A1] for a charge transport layer was applied to the charge generation layer and dried at 120° C. for 70 minutes.

Thus, a 21 μm-thick charge transport layer was formed on the surface of the charge generation layer.

### (A.2) Production of Photoreceptors 2 to 5

Photoreceptors 2 to 5 were produced in the same manner as the procedure for producing the photoreceptor 1 except that the content of silicon with respect to the total amount of the aluminum alloy was set to the content listed in Table I.

TABLE I

| | CONTENT OF SILICON |
|---|---|
| PHOTORECEPTOR NO. | [% BY MASS] |
| 1 | 0.7 |
| 2 | 12.6 |
| 3 | 0.9 |
| 4 | 0.5 |
| 5 | 13.0 |

### B. Production of Developer Bearing Member

### (B.1) Production of Developer Bearing Member 1

Developer bearing member 1 was produced according to the following procedure.

### (Production of Developing Sleeve)

### [Preparation of Support]

A cylindrical support made of an aluminum alloy was prepared.

The silicon content in the aluminum alloy of the cylindrical support is 0.5% by mass.

The cylindrical support is a thin-walled cylindrical support having an outer diameter of 16 mm, an inner diameter of 15 mm, and a thickness of 1 mm.

### [Sandblasting Treatment]

Glass beads were ejected onto the above-described developer bearing member with a blast gun to perform a sandblasting treatment on the outer circumferential surface of the cylinder, thereby producing a developing sleeve. The roughness (Rz) of the surface of the sleeve was 10 μm.

The processing conditions of the sandblasting treatment were as follows.

### <Processing Conditions>

Type of glass beads: FGB #80
Feed rate of glass beads: 200 g/min
Ejection distance from blast gun to cylinder: 100 mm
Movement speed of blast gun: 5.0 cm/sec
Compressed air pressure: 0.23 MPa
Rotation speed of cylinder: 545 rpm

### (Installation of Magnet Roller)

A developer bearing member 1 was produced by providing a magnet roller inside the above-described developing sleeve as illustrated in FIG. 4.

### (B.2) Production of Developer Bearing Members 2 to 5

Developer bearing members 2 to 5 were produced in the same manner as the production procedure of the developer bearing member 1 except that the silicon content in the aluminum alloy used in the developing sleeve was changed to the amount listed in Table II.

TABLE II

| DEVELOPER BEARING | CONTENT OF SILICON |
|---|---|
| MEMBER NO. | [% BY MASS] |
| 1 | 0.5 |
| 2 | 0.7 |
| 3 | 12.6 |
| 4 | 0.9 |
| 5 | 13.0 |

### C. Production of Carrier

### (C.1) Production of Coating Resin

### (C.1.1) Production of Coating Resin 1

To an aqueous solution of 0.3% by mass sodium benzenesulfonate, each monomer of cyclohexyl methacrylate/styrene was added at a mass ratio of (50:50).

Potassium peroxodisulfate in an amount corresponding to 0.5% by mass of the total amount of the respective monomers was added to perform emulsion polymerization, thereby preparing coating resin 1.

The weight average molecular weight of the coating resin 1 was measured using a known measurement device, and it was 500000.

### (C.1.2) Production of Coating Resins 2 to 5

Coating resins 2 to 5 were produced in the same manner as the production procedure of coating resin 1 except that the coating layer material was changed as described in Table III.

TABLE III

| | COATING LAYER MATERIAL | |
|---|---|---|
| COATING | | COMPOSITION RATIO |
| RESIN NO. | ABBREVIATION | (MASS RATIO) |
| 1 | CHMA/St | 50/50 |
| 2 | MMA/St | 50/50 |
| 3 | CHMA/MMA/MAA | 87/10/3 |
| 4 | CHMA/MAA | 98/2 |
| 5 | St/BA | 85/15 |

CHMA: CYCLOHEXYLMETHACRYLATE
St: STYRENE
MMA: METHYL METHACRYLATE
MAA: METHACRYLIC ACID
BA: BUTYL ACRYLATE

### (C.1) Production of Carrier 1

Carrier 1 was produced according to the following procedure.

### (Preparation of Core Material Particles)

Mn—Mg—Sr based “ferrite particles” having a volume-average particle diameter of 35 μm and saturation magnetizations of 61 A·m²/kg were prepared.

The ferrite particles had a volume resistance value of 4.5×10⁷ Ω·cm.

### (Coating of Core Material Particles)

To a high-speed mixer equipped with a stirring blade, 100 parts by mass of the “core material particles” prepared above and 3.55 parts by mass of the “coating resin 1” were charged.

At this time, the materials were mixed and stirred at 22° C. for 15 minutes under conditions in which the circumferential speed of the horizontal rotary wing was 8 m/sec.

The mixture was then mixed at 120° C. for 50 minutes to produce carrier 1 having a resin coating layer on the surface of the core material particle by the action of mechanical impact force (mechanochemical method).

The carrier 1 had a core material exposed area ratio of 19% and a volume resistance value of 10⁸ Ω·cm.

### (C.2) Production of Carriers 2 to 7 and 11 to 14

Carriers 2 to 7 and 11 to 14 were produced in the same manner as the production procedure of carrier 1 except that the type and the amount of the coating resin added were changed as described in Table IV.

### (C.3) Production of Carrier 8

To a high-speed mixer equipped with a stirring blade, 100 parts by mass of the “core material particles” prepared above and 3.75 parts by mass of the “coating resin 1” were charged.

At this time, 0.5 parts by mass of carbon black (volume resistance ratio: 1.2×10⁻¹ Ω·cm) having a particle diameter of 25 nm was charged as a resistance adjuster, and the materials were mixed and stirred at 22° C. for 15 minutes under conditions in which the circumferential speed of the horizontal rotary wing was 8 m/sec.

The mixture was then mixed at 120° C. for 50 minutes to produce carrier 8 having a resin coating layer on the surface of the core material particles by the action of mechanical impact force (mechanochemical method).

The carrier 8 had a core material exposed area ratio of 13% and a volume resistance value of 10¹ Ω·cm.

### (C.4) Production of Carriers 9 and 10

Carriers 9 and 10 were produced in the same manner as the production procedure of carrier 8 except that the resistance adjuster was changed as described in Table IV in the production of carrier 8.

TABLE IV

| | COATING | | | | | |
|---|---|---|---|---|---|---|
| | RESIN | | ADDITIVE | | EXPOSED | STATIC |
| | | AMOUNT | | AMOUNT | AREA | RESISTANCE |
| CARRIER | | [PARTS BY | | [PARTS BY | RATIO | VALUE |
| NO. | No. | MASS] | ABBREVIATION | MASS] | [%] | [Ω · cm] |
| 1 | 1 | 3.55 | — | — | 19 | 1.0 × 10⁸ |
| 2 | 1 | 4.00 | — | — | 9 | 1.0 × 10¹² |
| 3 | 1 | 3.75 | — | — | 13 | 1.0 × 10¹¹ |
| 4 | 2 | 3.75 | — | — | 13 | 1.0 × 10¹¹ |
| 5 | 3 | 3.75 | — | — | 13 | 1.0 × 10¹¹ |
| 6 | 4 | 3.75 | — | — | 13 | 1.0 × 10¹¹ |
| 7 | 5 | 3.75 | — | — | 13 | 1.0 × 10¹¹ |
| 8 | 1 | 3.75 | CB | 0.5 | 13 | 1.0 × 10⁹ |
| 9 | 1 | 3.75 | MgO | 0.5 | 13 | 1.0 × 10¹⁰ |
| 10 | 1 | 3.75 | TiO₂ | 0.5 | 13 | 1.0 × 10¹⁰ |
| 11 | 1 | 3.95 | — | — | 10 | 1.0 × 10¹¹ |
| 12 | 1 | 3.60 | — | — | 18 | 1.0 × 10⁹ |
| 13 | 1 | 3.40 | — | — | 22 | 9.4 × 10⁷ |
| 14 | 1 | 4.10 | — | — | 8 | 1.0 × 10¹³ |

CB: CARBON BLACK
MgO: MAGNESIUM OXIDE
TiO₂: TITANIUM DIOXIDE

### D. Preparation of Toner

Only one type of toner was prepared. This toner is referred to as toner 1.

### (D.1) Preparation of Amorphous Polyester Particle Dispersion (a1)

### (D.1.1) Preparation of Amorphous Polyester (A1)

Into a reaction vessel equipped with a stirrer, a thermometer, a condenser and a nitrogen gas introducing tube, the following monomer [1] and 0.25 parts by mass of “tin dioctanoate” with respect to 100 parts by mass of the total of the following monomer [1] were charged.

<Monomer [1]>

| | |
|---|---|
| Bisphenol A ethylene oxide 2.2 mol adduct | 40 parts by mole |
| Bisphenol A propylene oxide 2.2 mol adduct | 60 parts by mole |
| Dimethyl terephthalate | 60 parts by mole |
| Dodecenyl succinic anhydride | 20 parts by mole |

Under a nitrogen gas stream, the mixture was reacted in the reaction vessel at 235° C. for 6 hours.

Thereafter, the temperature in the reaction vessel was lowered to 200° C., 15 parts by mole of dimethyl fumarate and 5 parts by mole of trimellitic anhydride were added to the reaction vessel, and the mixture was allowed to react in the reaction vessel for 1 hour.

The temperature in the reaction vessel was increased to 220° C. over 5 hours, and polymerization was performed under 10 kPa pressures until a desired molecular weight was reached, to produce a pale-yellow transparent amorphous polyester (A1).

The amorphous polyester (A1) had a weight average molecular weight (Mw) of 35000, a number average molecular weight (Mn) of 8000, and a glass transition temperature (Tg) of 56° C.

### (D.1.2) Preparation of Amorphous Polyester (A1) Particle Dispersion

Next, the amorphous polyester (A1) and the following mixed solution [Ω] in the following amounts were placed in a separable flask, and were thoroughly mixed and dissolved.
Amorphous polyester [A1] 200.0 parts by mass

<Mixed Solution [2]>

| | |
|---|---|
| Methyl ethyl ketone | 100.0 parts by mass |
| Isopropyl alcohol | 35.0 parts by mass |
| 10% by mass aqueous ammonia solution | 7.0 parts by mass |

Thereafter, while the inside of the separable flask was heated and stirred at 40° C., ion exchanged water was added dropwise thereto at a liquid feeding rate of 8 g/min by using a liquid feeding pump.

When the amount of the ion exchanged water fed reached 580 parts by mass, the dropwise addition of the ion exchanged water was stopped.

Thereafter, the solvent was removed under reduced pressure to prepare a dispersion (a) of amorphous polyester particles.

Ion exchanged water was added to the dispersion (a) to adjust the solids content to be 25% by mass, thereby preparing an amorphous polyester particle dispersion (a1).

The volume-based median diameter (d50) of the amorphous polyester particles contained in the amorphous polyester particle dispersion (a1) was measured using Microtrac UPA-150 (manufactured by Nikkiso Co., Ltd.) and found to be 156 nm.

### (D.2) Preparation of Amorphous Vinyl Resin Particle Dispersion (b1)

Into a 5 L reaction vessel equipped with a stirring device, a temperature sensor, a cooling tube, and a nitrogen introduction device, 5.0 parts by mass of an anionic surfactant (DOWFAX manufactured by The Dow Chemical Company) and 2500 parts by mass of ion exchanged water were charged, the temperature in the reaction vessel was increased to 75° C. while stirring at a 230 rpm stirring speed under a nitrogen gas stream.

Next, a solution in which 18.0 parts by mass of potassium persulfate (KPS) was dissolved in 342 parts by mass of ion exchange water was added into the above reaction vessel, and the liquid temperature was set to 75° C.

Furthermore, a mixed liquid containing the following monomer [3] was added dropwise to the above reaction vessel in the following amount for 2 hours.

<Monomer [3]>

| | |
|---|---|
| Styrene (St) | 903.0 parts by mass |
| n-Butyl acrylate (BA) | 282.0 parts by mass |
| Acrylic acid (AA) | 12.0 parts by mass |
| 1,10-Decanediol diacrylate | 3.0 parts by mass |
| Dodecanethiol | 8.1 parts by mass |

After the completion of the dropwise addition, the mixture was heated and stirred at 75° C. for 2 hours to perform polymerization, thereby preparing a dispersion (b) of amorphous vinyl resin particles.

Ion exchanged water was added to the dispersion (b) to adjust the solids content to be 25% by mass, thereby preparing an amorphous vinyl resin particle dispersion (b1).

The “amorphous vinyl resin” contained in the amorphous vinyl resin particle dispersion (b1) is referred to as “amorphous vinyl resin (B1)”.

The volume-based median diameter (d50) of the amorphous vinyl resin particles contained in the amorphous vinyl resin particle dispersion (b1) was measured using Microtrac UPA-150 (manufactured by Nikkiso Co., Ltd.) and found to be 160 nm.

The amorphous vinyl resin (B1) had a glass-transition temperature (Tg) of 52° C., a weight average molecular weight (Mw) of 38000, and a number average molecular weight (Mn) of 15000.

### (D.3) Preparation of Crystalline Polyester Particle Dispersion (c1)

### (D.3.1) Production of Crystalline Polyester (C1)

The following monomers [4] were charged into a reaction vessel equipped with a stirrer, a thermometer, a condenser and a nitrogen gas introduction tube in the following amounts, and the atmosphere in the reaction vessel was replaced by dry nitrogen gas.

<Monomers [4]>

| | |
|---|---|
| Decanedioic acid | 50 parts by mole |
| 1,6-Hexanediol | 50 parts by mole |

Next, titanium tetrabutoxide (Ti(O-n-Bu)₄) was charged in an amount of 0.25 parts by mass with respect to 100 parts by mass of the total of the monomers [4].

Under a nitrogen gas stream, the temperature in the reaction vessel was set to 170° C., and the mixture was stirred and reacted for 3 hours.

Thereafter, the temperature in the reaction vessel was further increased to 210° C. over 1 hour, the pressure in the reaction vessel was reduced to 3 kPa, and the mixture was stirred and reacted under reduced pressure for 13 hours.

Through the above, crystalline polyester (C1) was obtained.

The crystalline polyester (C1) had a weight average molecular weight (Mw) of 25000, a number average molecular weight (Mn) of 8500, and a melting point of 71.8° C.

### (D.3.2) Preparation of Crystalline Polyester (C1) Particle Dispersion

Next, the crystalline polyester (C1) and a mixed liquid composed of the following mixed solution [5] were placed in a separable flask in the following amounts and thoroughly mixed and dissolved at 70° C., and then 8 parts by mass of a 10% by mass aqueous ammonia solution was added dropwise.
Crystalline polyester (C1) 200 parts by mass

<Mixed Solution [5]>

| | |
|---|---|
| Methyl ethyl ketone | 120 parts by mass |
| Isopropyl alcohol | 30 parts by mass |

Thereafter, while the heating temperature was lowered to 67° C. and the mixture was stirred, ion exchanged water was added dropwise at a liquid feeding rate of 8 g/min by using a liquid feeding pump.

When the amount of the ion exchanged water fed reached 580 parts by mass, the dropwise addition of the ion exchanged water was stopped.

Thereafter, the solvent was removed under reduced pressure to prepare a dispersion (c) of crystalline polyester particle dispersion.

Ion exchanged water was added to the dispersion (c) to adjust the solids content to be 25% by mass, thereby preparing a crystalline polyester particle dispersion (c1).

The volume-based median diameter (d50) of the crystalline polyester particles contained in the crystalline polyester particle dispersion (c1) was measured using Microtrac UPA-150 (manufactured by Nikkiso Co., Ltd.) and found to be 198 nm.

### (D.4) Preparation of Release Agent Particle Dispersion (W1)

The following release agent, surfactant, and ion exchanged water were mixed in the following amounts, and the release agent was dissolved at an internal liquid temperature of 120° C. using a pressure discharge-type homogenizer (Gaulin homogenizer, manufactured by Gaulin).

| | |
|---|---|
| “FNP0090” (release agent) | 270 parts by mass |
| “NEOGEN RK” (surfactant) | 13.5 parts by mass |
| Ion exchanged water | 21.6 parts by mass |

The release agent “FNP0090” (manufactured by NIPPON SEIRO CO., LTD.) is a paraffin-based wax and has a melting point of 89° C.

The surfactant “NEOGEN RK” (manufactured by DKS Co., Ltd) is an anionic surfactant.

Thereafter, the mixture was dispersed at dispersion pressures of 5 MPa for 120 minutes and then 40 MPa for 360 minutes, and cooled to obtain a dispersion (w).

Furthermore, ion exchanged water was added to adjust the dispersion (w) so that the solid content was 20%, and the obtained dispersion was set as a release agent particle dispersion (W1).

The volume average particle diameter of the particles in the release agent particle dispersion (W1) was 215 nm.

### (D.5) Preparation of Black Colorant Particle Dispersion (1)

The following colorant, surfactant, and ion exchanged water in the following amounts were mixed and pre-dispersed for 10 minutes with a homogenizer (ULTRA-TURRAX T50, manufactured by Ika-Werke GmbH & Co. KG).

| | |
|---|---|
| “Regal(R) 330” (colorant) | 100 parts by mass |
| “NEOGEN SC” (surfactant) | 15 parts by mass |
| Ion exchanged water | 400 parts by mass |

Note that the above-described “colorant” is carbon black (manufactured by Cabot Corp.).

The surfactant is an anionic surfactant (manufactured by DKS Co., Ltd).

Thereafter, a dispersion treatment was performed for 30 minutes at a pressure of 245 MPa by using a high-pressure impact type disperser ULTIMIZER (manufactured by Sugino Machine Limited) to obtain an aqueous dispersion of black colorant particles.

Ion exchanged water was further added to the aqueous dispersion of black colorant particles described above to adjust the solids content to be 15% by mass, thereby preparing a black colorant particle dispersion (1).

The volume-based median diameter (d50) of the colorant particles in the black colorant particle dispersion (1) was measured using Microtrac UPA-150 (manufactured by Nikkiso Co., Ltd.) and found to be 110 nm.

### (D.6) Preparation of Toner Base Particles 1

### (Aggregation-Fusion Process and Aging Process)

To a 4-liter reaction vessel equipped with a thermometer, a pH meter, and a stirrer, the dispersions prepared in (D.1) to (D.5) above, a surfactant, and ion exchanged water were charged in the following amounts, and the pH was adjusted to 3.0 by adding 1.0% nitric acid at a temperature of 25° C. to obtain a dispersion of raw materials.

| | |
|---|---|
| Amorphous polyester particle dispersion (a1) | 1008 parts by mass |
| Amorphous vinyl resin particle dispersion (b1) | 32 parts by mass |
| Crystalline polyester particle dispersion (c1) | 160 parts by mass |
| Release agent particle dispersion (W1) | 160 parts by mass |
| Black colorant particle dispersion (1) | 187 parts by mass |
| “Dowfax2A1” (surfactant) | 40 parts by mass |
| Ion exchanged water | 1500 parts by mass |

Note that the above-described surfactant is an anionic surfactant.

Thereafter, 100 parts by mass of an aggregating agent is added dropwise over 30 minutes while dispersing at 3000 rpm using a homogenizer “ULTRA-TURRAX T50” (manufactured by Ika-Werke GmbH & Co. KG).

As the aggregating agent, an aqueous aluminum sulfate solution having a concentration of 2% was used.

After the completion of the dropwise addition of the aggregating agent, the mixture was stirred for 10 minutes to sufficiently mix the dispersion of raw materials and the aggregating agent.

Thereafter, a stirrer and a mantle heater were installed in the reaction vessel.

While the rotation speed of the stirrer was adjusted so that the slurry was sufficiently stirred, the temperature increase rate was set to 0.2° C./min until the temperature in the reaction vessel became 40° C.

After the temperature in the reaction vessel higher than 40° C., the temperature was increased at the temperature increase rate of 0.05° C./min, and the particle diameter was measured every 10 minutes using “Coulter Multisizer 3” (aperture diameter 100 μm, manufactured by Beckman Coulter, Inc.).

When the volume-based median diameter of the particles in the dispersion of the raw materials reached 3.9 μm, the temperature was maintained, and a mixed liquid of the following amorphous polyester particle dispersion (a1) and a surfactant, which had been mixed in advance, was charged into the reaction vessel over 20 minutes.

<Mixed Liquid>

| | |
|---|---|
| Amorphous polyester particle dispersion (a1) | 400 parts by mass |
| “Dowfax2A1” (surfactant) | 15 parts by mass |

Note that the above-described surfactant is an anionic surfactant.

Next, the inside of the reaction vessel was maintained at 50° C. for 30 minutes, and then 8 parts by mass of a 20% solution of ethylenediaminetetraacetic acid (EDTA) was added to the reaction vessel.

Thereafter, 1 mol/L of an aqueous sodium hydroxide solution was added to the reaction vessel, and the pH of the raw material dispersion in the reaction vessel was controlled to 9.0.

Thereafter, the temperature was increased to 85° C. at the temperature increase rate of 1° C./min while the pH was adjusted to 9.0 by every 5° C. increase, and then the temperature was maintained at 85° C.

### (Cooling Process)

Thereafter, using “FPIA-3000”, when the shape factor reached 0.970, the mixture was cooled at a temperature decrease rate of 10° C./min to prepare a toner base particle dispersion (1).

### (Filtration-Washing Process and Drying Process)

Thereafter, the toner base particle dispersion (1) was filtered, thoroughly washed with ion exchanged water, and dried at 40° C. to produce toner base particles (1).

The produced toner base particles (1) had a volume-based median diameter of 4.0 μm and an average circularity of 0.971.

### (D.7) Addition of External Additive

The following external additives were added in the following amounts to the toner base particles (1) produced above, and mixing was performed using a Henschel mixer (manufactured by Mitsui Miike Chemical Engineering Machinery Co., Ltd.).

### <External Additive>

Hydrophobic silica (number-average primary particle diameter 12 nm, degree of hydrophobicity 68) 1.0% by mass
Hydrophobic titanium oxide (number average primary particle diameter 20 nm, degree of hydrophobicity 64) 1.5% by mass

Thereafter, coarse particles were removed using a sieve with an opening of 45 μm to prepare “toner 1”.

### E. Preparation of Developer

### (E.1) Preparation of Developer

The carrier 1 produced in (C.1) to (C.4) described above and the toner 1 produced in (D.1) to (D.7) described above were charged into a V-type mixer in the following amounts and mixed for 5 minutes under a normal temperature and normal humidity environment to prepare a developer 1.

| | |
|---|---|
| Carrier 1 | 100 parts by mass |
| Toner 1 | 6 parts by mass |

### (E.2) Preparation of Developers 2 to 14

Developers 2 to 14 were prepared in the same manner as in the production procedure of the developer 1 except that the type of the carrier was changed as in Table XVI from carrier 1.

TABLE V

| DEVELOPER NO. | TONER NO. | CARRIER NO. |
|---|---|---|
| 1 | 1 | 1 |
| 2 | 1 | 2 |
| 3 | 1 | 3 |
| 4 | 1 | 4 |
| 5 | 1 | 5 |
| 6 | 1 | 6 |
| 7 | 1 | 7 |
| 8 | 1 | 8 |
| 9 | 1 | 9 |
| 10 | 1 | 10 |
| 11 | 1 | 11 |
| 12 | 1 | 12 |
| 13 | 1 | 13 |
| 14 | 1 | 14 |

### F. Evaluation

### (F.1) Image Failure Due to Charge Leakage

### (Evaluation Method)

To a commercially available color multifunction peripheral “bizhub C450i” (manufactured by Konica Minolta, Inc.), a photoreceptor, a developer bearing member, and a developer were loaded in the combinations listed in Table VI, and 10 copies were output on POD gloss coat (A3 size, 100 g/m², manufactured by Oji Paper Co., Ltd.) under conditions of Vₒ=−550 V, Vdc=−400 V, frequency=4 kHz, and Vpp=1.5 kV in a normal-temperature and normal-humidity environment (temperature of 20° C. and relative humidity of 50% RH).

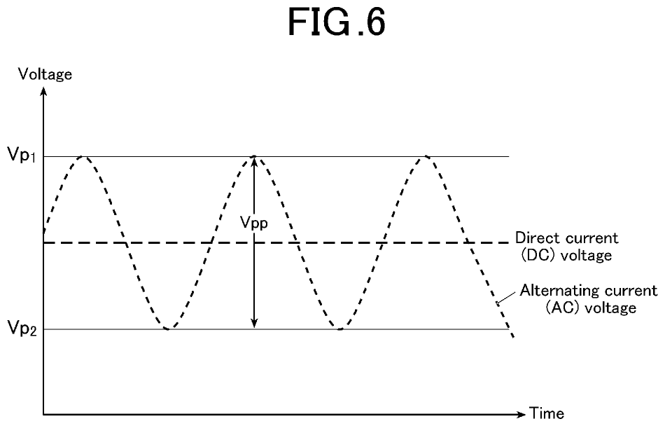

Note that Vₒ is the surface potential of the photoreceptor, Vdc is a DC voltage, and Vpp is the absolute value of the difference (|Vp₁−Vp₂|) between the minimum value (Vp₁) and the maximum value (Vp₂) of an AC voltage waveform (see FIG. 6).

At this time, the DC voltage Vdc is represented by (Vp₁−Vp₂)/2.

TABLE VI

| | | DEVELOPER | |
|---|---|---|---|
| EXAMPLE OR | PHOTO- | BEARING | |
| COMPARATIVE | RECEPTOR | MEMBER | DEVELOPER |
| EXAMPLE | NO. | NO. | NO. |
| EXAMPLE 1 | 1 | 1 | 3 |
| EXAMPLE 2 | 2 | 1 | 3 |
| EXAMPLE 3 | 3 | 1 | 1 |
| EXAMPLE 4 | 3 | 1 | 2 |
| EXAMPLE 5 | 3 | 1 | 3 |
| EXAMPLE 6 | 3 | 1 | 4 |
| EXAMPLE 7 | 3 | 1 | 5 |
| EXAMPLE 8 | 3 | 1 | 6 |
| EXAMPLE 9 | 3 | 1 | 7 |
| EXAMPLE 10 | 3 | 1 | 8 |
| EXAMPLE 11 | 3 | 1 | 9 |
| EXAMPLE 12 | 3 | 1 | 10 |
| EXAMPLE 13 | 3 | 1 | 11 |
| EXAMPLE 14 | 3 | 1 | 12 |
| EXAMPLE 15 | 4 | 2 | 3 |
| EXAMPLE 16 | 4 | 3 | 3 |
| EXAMPLE 17 | 4 | 4 | 1 |
| EXAMPLE 18 | 4 | 4 | 2 |
| EXAMPLE 19 | 4 | 4 | 3 |
| EXAMPLE 20 | 4 | 4 | 4 |
| EXAMPLE 21 | 4 | 4 | 5 |
| EXAMPLE 22 | 4 | 4 | 6 |
| EXAMPLE 23 | 4 | 4 | 7 |
| EXAMPLE 24 | 4 | 4 | 8 |
| EXAMPLE 25 | 4 | 4 | 9 |
| EXAMPLE 26 | 4 | 4 | 10 |
| EXAMPLE 27 | 4 | 4 | 11 |
| EXAMPLE 28 | 4 | 4 | 12 |
| EXAMPLE 29 | 3 | 4 | 3 |
| COMPARATIVE | 4 | 1 | 3 |
| EXAMPLE 1 | | | |
| COMPARATIVE | 5 | 1 | 3 |
| EXAMPLE 2 | | | |
| COMPARATIVE | 3 | 4 | 13 |
| EXAMPLE 3 | | | |
| COMPARATIVE | 3 | 4 | 14 |
| EXAMPLE 4 | | | |
| COMPARATIVE | 4 | 5 | 3 |
| EXAMPLE 5 | | | |
| COMPARATIVE | 5 | 5 | 3 |
| EXAMPLE 6 | | | |
| COMPARATIVE | 3 | 4 | 13 |
| EXAMPLE 7 | | | |
| COMPARATIVE | 3 | 4 | 14 |
| EXAMPLE 8 | | | |

Images in ten sheets were visually observed and the image evaluation was performed with respect to the occurrence of image failures (black spots) due to leakage in accordance with the following evaluation criteria.

### (Evaluation Criteria)

A No image failure due to leakage is observed in any of the ten sheets.
B Image failure due to leakage is observed in at least any of the ten sheets, and the total number of failure occurrence places is from 1 to 3.
C Image failure due to leakage is observed in at least any of the ten sheets, and the total number of failure occurrence places is from 4 to 9.
D Image failure due to leakage is observed in at least any of the ten sheets, and the total number of failure occurrence places is 10 or more.

### (F.2) Image Density in Low-Temperature and Low-Humidity Environment

### (Evaluation Method)

The evaluation apparatus was allowed to stand in a low-temperature and low-humidity environment (10° 020%) for a whole day and night, and then a solid image at a 10 cm angle was printed. The image density was measured at 10 random places with a reflection densitometer “RD-918 (manufactured by Macbeth)”, and the mean density was defined as the image density.

Those having an image density of 1.20 or more were determined to have no practical problem and accepted the test.

### (Evaluation Criteria)

A 1.70 or more
B 1.50 or more and less than 1.70
C 1.20 or more and less than 1.50
D less than 1.20

### G. General Remarks

Table VII summarizes the silicon contents of the photoreceptor and the developer bearing member, the values related to the carrier contained in the developer, the evaluation results, and the like of Examples or Comparative Examples according to the combinations in Table VI.

TABLE VII

| | IMAGE | IMAGE |
|---|---|---|
| | FAILURE | DENSITY (LOW- |
| EXAMPLE OR | DUE TO | TEMPERATURE |
| COMPARATIVE | CHARGE | AND LOW-HUMIDITY |
| EXAMPLE | LEAKAGE | ENVIRONMENT) |
| EXAMPLE 1 | A | A |
| EXAMPLE 2 | C | A |
| EXAMPLE 3 | B | B |
| EXAMPLE 4 | B | C |
| EXAMPLE 5 | B | A |
| EXAMPLE 6 | B | A |
| EXAMPLE 7 | B | A |
| EXAMPLE 8 | B | A |
| EXAMPLE 9 | B | A |
| EXAMPLE 10 | B | B |
| EXAMPLE 11 | B | B |
| EXAMPLE 12 | B | B |
| EXAMPLE 13 | B | A |
| EXAMPLE 14 | B | B |
| EXAMPLE 15 | A | A |
| EXAMPLE 16 | C | A |
| EXAMPLE 17 | B | B |
| EXAMPLE 18 | B | C |
| EXAMPLE 19 | B | A |
| EXAMPLE 20 | B | A |
| EXAMPLE 21 | B | A |
| EXAMPLE 22 | B | A |
| EXAMPLE 23 | B | A |
| EXAMPLE 24 | B | B |
| EXAMPLE 25 | B | B |
| EXAMPLE 26 | B | B |
| EXAMPLE 27 | B | A |
| EXAMPLE 28 | B | B |
| EXAMPLE 29 | A | A |
| COMPARATIVE | D | C |
| EXAMPLE 1 | | |
| COMPARATIVE | D | A |
| EXAMPLE 2 | | |
| COMPARATIVE | A | D |
| EXAMPLE 3 | | |
| COMPARATIVE | A | D |
| EXAMPLE 4 | | |
| COMPARATIVE | D | A |
| EXAMPLE 5 | | |
| COMPARATIVE | A | D |
| EXAMPLE 6 | | |
| COMPARATIVE | A | D |
| EXAMPLE 7 | | |
| COMPARATIVE | A | D |
| EXAMPLE 8 | | |

Note that the meanings of the respective symbols and the like in Table VII are as follows.
CHMA: cyclohexylmethacrylate
St: styrene
MMA: methyl methacrylate
MAA: methacrylic acid
BA: butyl acrylate
CB: carbon black
MgO: magnesium oxide
TiO₂: titanium dioxide
*1: image evaluation with leakage
*2: image density in low-temperature and low-humidity environment

As shown in Table VII, unlike the evaluation of Comparative Examples, Examples are not evaluated as “D” in the image failure due to charge leakage and the image density in the low-temperature and low-humidity environment. This shows that, in Examples, excessive charging of the toner for developing electrostatic charge image is suppressed, and satisfactory images can be obtained even in a low-temperature and low-humidity environment.

The expression mechanism or action mechanism of the effect of the present invention is not clear, but it is presumed as follows.

The image forming system of the present invention is an image forming system comprising: a two-component developer; and an image forming apparatus comprising at least one of a photoreceptor including a support made of an aluminum alloy or a developer bearing member including a developing sleeve made of an aluminum alloy, wherein a static resistance value of a carrier contained in the two-component developer is in a range of 10 Ω·cm or more and less than 10¹² Ω·cm, and a silicon content in the aluminum alloy forming at least the support of the photoreceptor or the developing sleeve of the developer bearing member is in a range of more than 0.6% by mass and 12.6% by mass or less.

In a support of an electrophotographic photoreceptor made of an aluminum alloy, as the silicon content in the aluminum alloy increases, a larger number of coarse crystals (convex portions) due to the eutectic crystal of silicon and aluminum are present on the surface.

When an image is formed using a photoreceptor having such a support, an electric field tends to concentrate on such convex portions, which tends to cause charge leakage between the outermost surface of the photoreceptor and the support of the photoreceptor.

When such charge leakage occurs, the absolute value of the potential of the surface of the photoreceptor partially decreases, and a local image failure (black spot) is likely to occur on the formed image.

Meanwhile, also in a developer bearing member having a developing sleeve using an aluminum alloy, as the silicon content in the aluminum alloy increases, a larger number of coarse crystals (convex portions) due to the eutectic crystal of silicon and aluminum are present on the surface.

In a case where image formation is performed using such a developer bearing member, charge leakage is likely to occur between the convex portions on the surface of the developing sleeve and the surface of the photoreceptor due to the application of voltage during development.

When such charge leakage occurs, the absolute value of the potential of the surface of the photoreceptor partially decreases, and a local image failure (black spot) is likely to occur on the formed image.

As can be seen from the foregoing, reasons are different between a support of an electrophotographic photoreceptor made of an aluminum alloy having a silicon content in a certain range and a developer bearing member having a developing sleeve made of the aluminum alloy. However, they are common in that local image failures (black spots) occur due to occurrence of charge leakage.

Thus, both of them are common in that a means for suppressing charge leakage is required.

As a means for suppressing the leakage of the charge generated between the outermost surface of the photoreceptor and the photoreceptor support, it is considered to reduce the absolute value of the surface potential of the photoreceptor when the photoreceptor is charged.

In that case, the absolute value of a development potential to be applied to the developer bearing member also needs to be reduced to suppress toner development on a non-image area (so-called image fog), which may cause difficulty in ensuring image density in a low-temperature and low-humidity environment in which the charge amount of the toner tends to increase.

On the other hand, as a means for suppressing the leakage of the charge generated between the convex portions on the surface of the developing sleeve and the surface of the photoreceptor, it is considered to reduce the absolute value of the developing potential applied to the developer bearing member. However, in this case, it may be difficult to ensure image density, particularly in a low-temperature and low-humidity environment in which the charge amount of the toner tends to increase.

In the present invention, during image formation, any of the following three combinations is used: (1) a photoreceptor support made of an aluminum alloy having a silicon content in a certain range and a two-component developer, (2) a developing sleeve made of an aluminum alloy having a silicon content in a certain range and a two-component developer, or (3) a photoreceptor support made of an aluminum alloy having a silicon content in a certain range and a developing sleeve made of an aluminum alloy having a silicon content in a certain range and a two-component developer. Furthermore, the resistance value of the carrier contained in the two-component developer is adjusted to a specific range.

By adjusting the resistance value, charges are appropriately released from the carrier particles when the toner and the carrier are frictionally charged, and thus excessive charging of the toner is suppressed. It is thus presumed that an image with sufficient density can be obtained particularly in low-temperature and low-humidity environments.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-118727 filed on Jul. 21, 2023 is incorporated herein by reference in its entirety.

What is claimed is:

1. An image forming system comprising:
a two-component developer; and
an image forming apparatus comprising at least one of a photoreceptor including a support made of an aluminum alloy or a developer bearing member including a developing sleeve made of an aluminum alloy, wherein
a static resistance value of a carrier contained in the two-component developer is in a range of 10⁸ Ω·cm or more and less than 10¹² Ω·cm, and
a silicon content in the aluminum alloy forming at least the support of the photoreceptor or the developing sleeve of the developer bearing member is in a range of more than 0.6% by mass and 12.6% by mass or less.

2. The image forming system according to claim 1, wherein the carrier is composed of carrier particles in which at least a surface of core material particles is coated with a coating resin,
wherein the coating resin has a structure derived from a (meth)acrylate.

3. The image forming system according to claim 2, wherein the coating resin contains at least one of carbon black, magnesium oxide, or titanium dioxide.

4. The image forming system according to claim 2, wherein an exposed area ratio of the core material particles in a surface of the carrier particles is in a range of 10.0 to 18.0% based on a surface area of the core material particles.

5. The image forming system according to claim 1, wherein the silicon content is in a range of more than 0.8% by mass and 12.6% by mass or less based on a total amount of the aluminum alloy forming at least the support of the photoreceptor or the developing sleeve of the developer bearing member.

6. The image forming system according to claim 2, wherein the coating resin has a structure derived from an alicyclic (meth)acrylate.

7. The image forming system according to claim 1, wherein a static resistance value of the carrier is in a range of 10⁸ to 10¹⁰ Ω·cm.

8. An image forming method using:
a two-component developer; and
an image forming apparatus comprising at least one of a photoreceptor including a support made of an aluminum alloy or a developer bearing member including a developing sleeve made of an aluminum alloy, wherein
a static resistance value of a carrier contained in the two-component developer is in a range of 10⁸ Ω·cm or more and less than 10¹² Ω·cm, and
a silicon content in the aluminum alloy forming at least the support of the photoreceptor or the developing sleeve of the developer bearing member is in a range of more than 0.6% by mass and 12.6% by mass or less.
